(19) United States
(12) Patent Application Publication
(10) Pub. No.: US 2026/0129558 A1
(43) Pub. Date: May 7, 2026

(54) METHODS, ARCHITECTURES, APPARATUSES AND SYSTEMS FOR MULTI-RADIO SPECTRUM SHARING CELL ACCESS BROADCAST TRANSMISSION

(71) Applicant: InterDigital Patent Holdings, Inc., Wilmington, DE (US)

(72) Inventors: Tao Deng, New York, NY (US); Moon IL Lee, Melville, NY (US); Paul Marinier, Brossard (CA); Faris Alfarhan, Montreal (CA); Jaya Rao, Montreal (CA); Umer Salim, Vallauris (FR)

(21) Appl. No.: 18/936,219

(22) Filed: Nov. 4, 2024

(51) Int. Cl. H04W 48/10; H04W 16/14

(52) U.S. Cl. CPC H04W 48/10; H04W 16/14

(57) ABSTRACT

Procedures, methods, architectures, apparatuses, systems, devices, and computer program products related to multi-radio spectrum sharing (MRSS) cell access are described. One method may include receiving, in a cell access broadcast channel, a cell access broadcast transmission associated with a first radio access technology, determining that cell access information associated with the first radio access technology is received in the cell access broadcast transmission, determining that cell access information associated with a second radio access technology is received in the cell access broadcast channel, determining the cell access information associated with the second radio access technology based on reserved bits in the cell access broadcast channel and the cell access information associated with the first radio access technology, and receiving cell system information associated with the second radio access technology using the determined cell access information associated with the second radio access technology.

### FIELD

Example embodiments described in the present disclosure are generally directed to the fields of communications, software and encoding, including, for example, to methods, architectures, apparatuses, systems related to multi-radio spectrum sharing (MRSS) cell access.

### BACKGROUND

It is expected that operators will deploy 6th generation (6G) systems in both existing and new spectrums. In the existing spectrum, 5th generation (5G) and 6G base stations (e.g., gNBs) operated by one operator may be co-located. 5G and 6G Radio Access Technology (RAT) co-existence in a shared spectrum is referred to as multi-radio spectrum sharing (MRSS) and can facilitate a gradual migration to stand-alone 6G RAT in the spectrum.

### SUMMARY

Some embodiments may be directed to a wireless transmit/receive unit (WTRU) that includes circuitry, such as any of a processor, memory, transmitter and receiver. The circuitry may be configured to receive a cell access broadcast transmission associated with a first radio access technology, where the cell access broadcast transmission is received on a cell access broadcast channel, determine that cell access information associated with the first radio access technology is received in the cell access broadcast transmission, determine, based on an unused bit in the cell access broadcast channel, that cell access information associated with a second radio access technology is received in the cell access broadcast channel, determine the cell access information associated with the second radio access technology based on reserved bits in the cell access broadcast channel and the cell access information associated with the first radio access technology, and receive cell system information associated with the second radio access technology using the determined cell access information associated with the second radio access technology.

Some embodiments may include a method implemented by a WTRU. The method may include receiving a cell access broadcast transmission associated with a first radio access technology, where the cell access broadcast transmission is received on a cell access broadcast channel, determining that cell access information associated with the first radio access technology is received in the cell access broadcast transmission, determining, based on an unused bit in the cell access broadcast channel, that cell access information associated with a second radio access technology is received in the cell access broadcast channel, determining the cell access information associated with the second radio access technology based on reserved bits in the cell access broadcast channel and the cell access information associated with the first radio access technology, and receiving cell system information associated with the second radio access technology using the determined cell access information associated with the second radio access technology.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of overlapping coverage of 5G and 6G MRSS cells, according to an embodiment;

FIG. 3 illustrates an example flow diagram of a method, according to some embodiments; and

FIG. 4 illustrates an example of cell access broadcast transmissions in a 5G/6G MRSS cell, according to certain embodiments;

FIG. 5 illustrates an example of WTRU reception of 6G cell access broadcast transmission based on the information indicated or included in a 5G cell access broadcast transmission, according to certain embodiments;

FIG. 6 illustrates an example of WTRU reception of a 6G broadcast indication channel associated with 5G synchronization signal transmission, according to certain embodiments; and

FIG. 7 illustrates an example flow diagram of a method, according to some embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

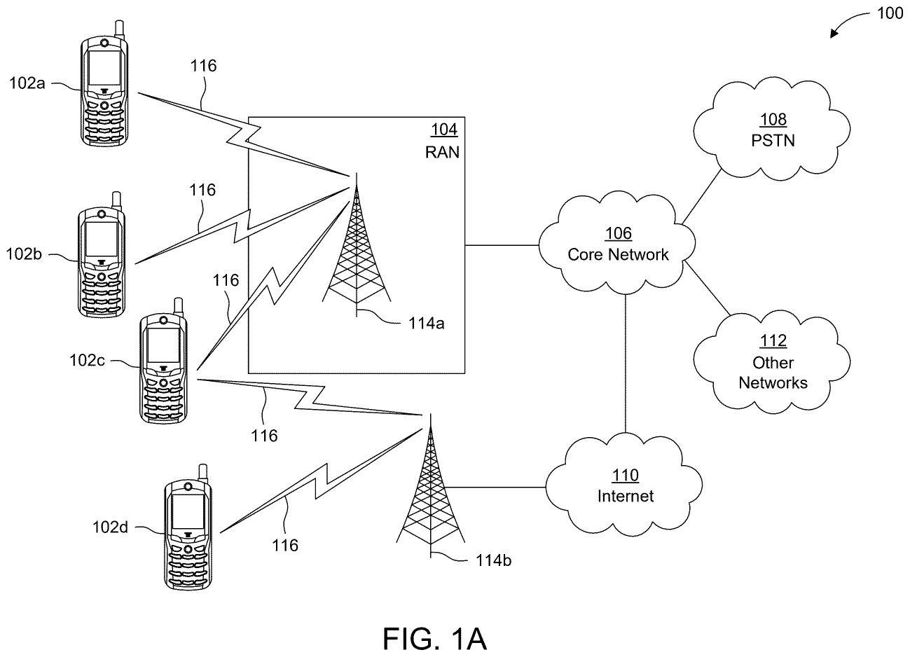

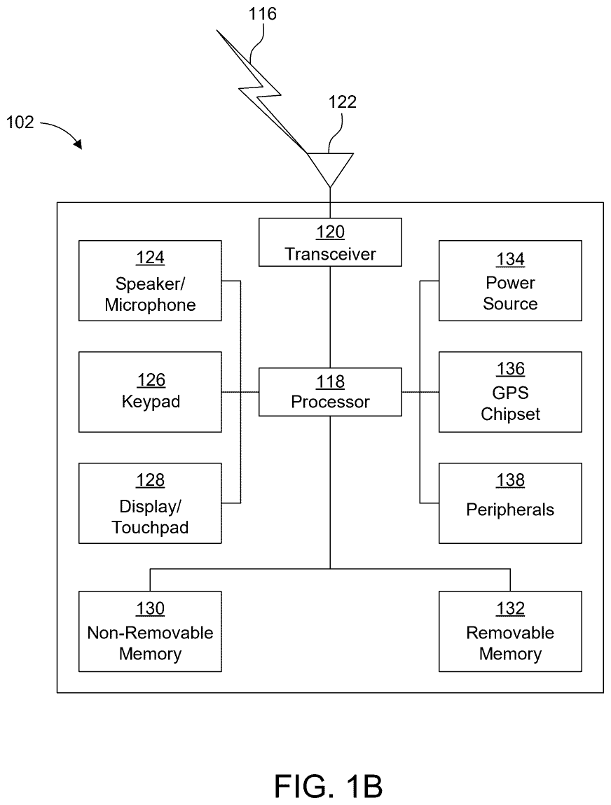

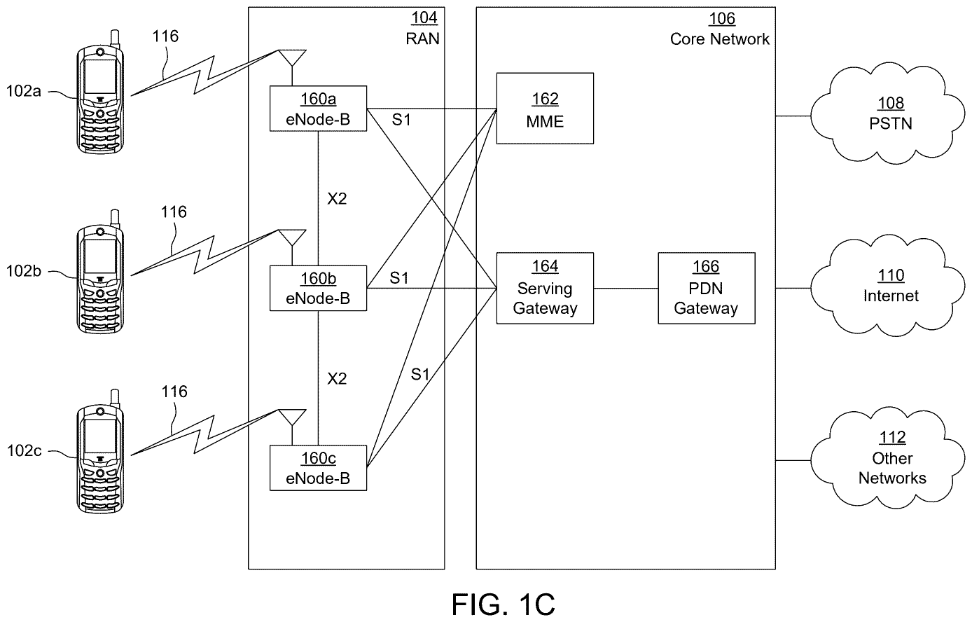

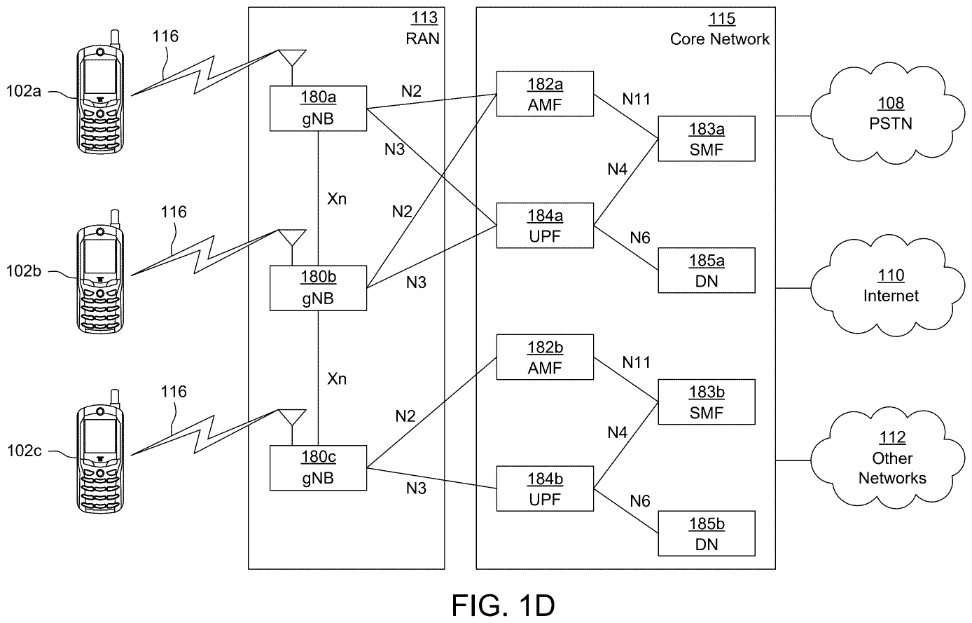

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (CNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (cMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments disclosed herein are representative and do not limit the applicability of the apparatus, procedures, functions and/or methods to any particular wireless technology, any particular communication technology and/or other technologies. The term network in this disclosure may generally refer to one or more base stations or gNBs or other network entity which in turn may be associated with one or more Transmission/Reception Points (TRPs), or to any other node in the radio access network.

It is noted that, throughout example embodiments described herein, the terms “base station”, “serving base station”, “RAN,” “RAN node,” “Access Network,” “NG-RAN,” “gNodeB,” and/or “gNB” may be used interchangeably to designate any network element such as, e.g., a network element acting as a serving base station. It should be understood that embodiments described herein are not limited to gNBs and are applicable to any other types of base stations.

A new radio (NR) cell access broadcast transmission may include periodically transmitted Synchronization Signal Blocks (SSBs). A SSB includes a Primary Synchronization Signal (PSS), Secondary Synchronization Signal (SSS) and Physical Broadcast Channel (PBCH). Multiple SSBs can be transmitted at different frequency locations within a NR carrier of a serving cell. Each frequency location is pre-configured by Global Synchronization Channel Number (GSCN) and the frequency interval between GSCNs is pre-defined as sync raster.

The physical layer sequences used for PSS and SSS provide a WTRU with Physical Cell Identity (PCI) of the cell. The PBCH can carry a Master Information Block (MIB) and provide necessary information for a WTRU to receive System Information Block 1 (SIB1) transmitted in the cell in order to acquire cell access. The information necessary to receive SIB1 transmission can include, e.g., physical downlink shared channel (PDSCH) demodulation reference signal (DMRS) position, Sub-Carrier Spacing (SCS), physical downlink control channel (PDCCH) resource configuration, cell-baring information, etc. A SSB including a PBCH associated with SIB1 transmission and thus leading to cell access information acquisition is referred to as Cell-Defining SSB (CD-SSB). A CD-SSB is transmitted (e.g., always transmitted) in a Primary Cell (PCell) on a GSCN.

In NR, a SSB not associated with SIB1 can also be transmitted. Such a SSB does not lead to a reception of cell access information included in SIB1 and is referred to as Non-Cell-Defining SSB (NCD-SSB). Accordingly, a WTRU cannot acquire cell access based on a received NCD-SSB. One or multiple NCD-SSBs can be transmitted in a cell and at a different periodicity than that of CD-SSB.

Information related to cell access in PBCH, e.g., PDCCH resource configuration are not used when a WTRU receives a NCD-SSB transmission. Other information such as System Frame number (SFN), sub-carrier spacing (SCS) and DMRS position are used for time and frequency synchronization, measurements, Radio Link Monitoring (RLM), Beam Failure Detection (BFD), etc. NCD-SSB was first introduced in 3GPP Release-17 for Reduced Capability UE (RedCap UE).

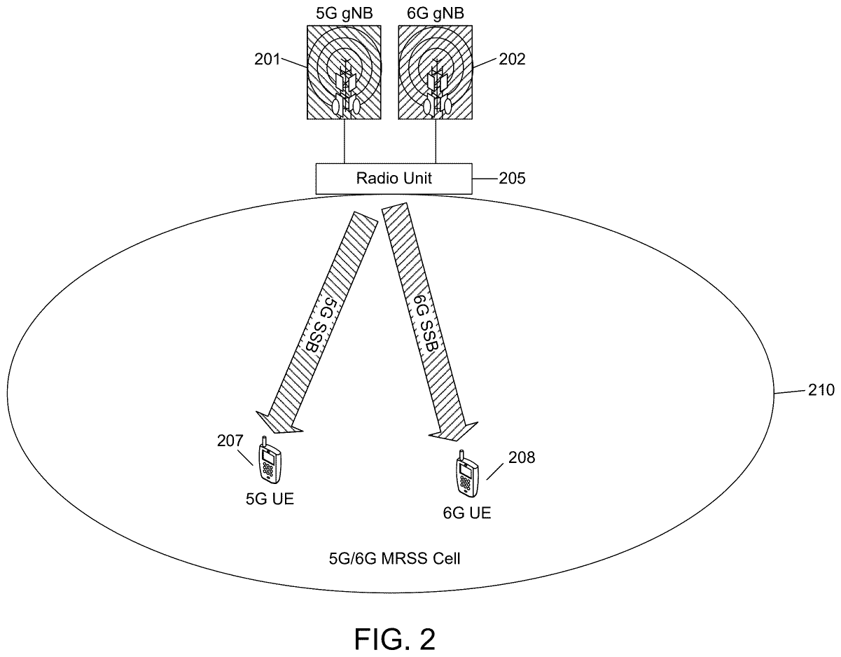

It is expected that operators will deploy 6G system(s) in both existing and new spectrums. In the existing spectrum, 5G and 6G base stations (e.g., gNBs) operated by one operator may be co-located. Furthermore, the 5G and 6G base stations (e.g., gNBs) may share a radio unit (RU) and provide overlapping coverage of 5G and 6G cell within one carrier, as illustrated in FIG. 2. More specifically, FIG. 2 illustrates an example in which a 5G gNB 201 and 6G gNB 202 may share RU 205 and may transmit a 5G SSB and 6G SSB, respectively, to a 5G WTRU 207 and 6G WTRU 208 within the overlapping coverage of the 5G and 6G cell 210. 5G and 6G Radio Access Technology (RAT) co-existence in shared spectrum is referred to as Multi-Radio Spectrum Sharing (MRSS) and can facilitate a gradual migration to stand-alone 6G RAT in the spectrum.

A 6G WTRU in a 6G MRSS cell is also within the coverage of a 5G cell. More importantly, the cell access information of the cells of different RAT can have many similarities, e.g., the resource grid configuration, the sub-carrier spacing, Bandwidth Part (BWP), etc. It is thus discussed to consider a synergy between two RATs within the overlapping coverage to achieve a more efficient 6G operation.

In 6G deployment(s), a 6G base station (e.g., gNB) can be co-located with a 5G base station (e.g., gNB) and use the same radio hardware for operation in shared spectrum to provide a 6G MRSS cell coverage. As a result, a 6G MRSS cell and 5G cell can have overlapping coverage with a potentially considerable amount of similar or identical cell access information. Independent and parallel 5G and 6G cell access broadcast transmissions, as illustrated in FIG. 2, to convey two sets of mostly identical (or similar) cell access information can result in unnecessary signaling overhead and inefficient network energy consumption.

In 4G LTE and 5G Dynamic Spectrum Sharing (DSS) sharing, due to the significant change in radio access design (e.g., introduction of beamforming and flexible numerology), independent 4G and 5G cell access broadcast transmissions of different physical layer signaling and structure are applied. In 6G MRSS, it is however conceivable that a 6G radio access design is potentially compatible with 5G radio access (e.g., in terms of physical layer signaling and structure) and thus a new approach of 6G cell broadcast transmission in 6G MRSS cell can be considered to enable benefits such as signaling overhead reduction and network energy saving. Hence, a problem arises regarding how to take advantage of 5G cell synchronization and broadcast transmission in a 6G MRSS cell to enable efficient 6G cell access information transmissions with reduced signaling overhead.

In addition, sparse broadcast transmission for cell access information, e.g., a CD-SSB transmission with a large periodicity (e.g. >160 ms) has been evaluated in 5G Release-19 to improve network energy saving. Configuration and indication signaling from a Primary Cell (PCell) is introduced in Release-19 to enable a sparse CD-SSB transmission in an associated Secondary Cell (SCell). However, a sparse cell access broadcast transmission in a PCell can negatively impact WTRU initial cell access performance, e.g., increased WTRU processing and cell access latency. This issue can further be addressed in 6G cell access broadcast transmission design. Thus, a problem arises with respect to how to enable sparse 6G cell access broadcast transmission while mitigating the negative impact to WTRU initial cell access performance.

It is noted that, although certain example embodiments described herein refer to 5G and 6G radio access technologies, example embodiments may also be applicable to other current or future types of radio access technologies and are not limited to 5G and 6G systems.

According to certain embodiments, a WTRU may be (pre)configured to detect and/or receive a cell access broadcast transmission to acquire cell access information. A WTRU may apply the received cell access information to access a cell, e.g., to receive cell system information in a data transmission (e.g., SIB1 transmission) of the cell and initiate a RACH procedure to establish a connection with the cell. A cell access broadcast transmission may include transmissions of synchronization signal(s) and cell access broadcast channel. In accordance with certain embodiments, a cell access broadcast channel may be referred to as and exchangeable with PBCH, and a cell access broadcast transmission may be referred to as and exchangeable with SSB.

A cell access broadcast channel, e.g. PBCH, may carry cell access information required to acquire cell system information, e.g. in SIB1. The cell access information may include configuration for PDCCH transmission scheduling the data channel carrying SIB1 information. In certain embodiments, when a PBCH may carry such cell access information, the SSB transmission including the PBCH may be referred to as CD-SSB. When a PBCH may not carry such cell access information, the SSB transmission including the PBCH may be referred to as NCD-SSB.

In some embodiments, a WTRU may perform at least the following for detecting and/or receiving the cell access broadcast transmission: synchronization detection and reception, PBCH decoding and reception, and cell access information acquisition.

For synchronization detection and reception, a WTRU may detect and receive one or more synchronization signal(s), e.g., a Primary Synchronization Signal (PSS) and/or a Secondary Synchronization Signal (SSS). A WTRU may be (pre)configured with a set of synchronization signal sequences. Each (pre)configured synchronization signal sequence may be of the same sequence type and with a different time and/or cyclic shift. The sequence type may be, e.g., Zadoff Chu (ZC) sequence, M sequence and/or Gold sequence. A (pre)configured synchronization signal sequence may be indicated with a sequence index corresponding to its time and/or cyclic shift.

A WTRU may detect a synchronization signal by performing a correlation between a received signal and one or more (pre)configured synchronization signal sequences. A WTRU may determine a synchronization signal may be detected and received when a correlation result, e.g., energy and/or power using a synchronization sequence indicated by a sequence index may exceed a (pre)configured threshold. A WTRU may determine a reference timing, e.g., a symbol timing, a slot timing and/or sub-frame based on the timing of the detected synchronization signal sequence. A WTRU may synchronize its reference timing and frequency based on the received synchronization signal(s).

A WTRU may determine a physical layer cell identity (PCI) based on the index(es) of detected and received synchronization signal(s). For example, a WTRU may apply a (pre) configure formula to compute a 5G NR PCI as a function of the indexes of PSS and SSS.

For PBCH decoding and reception, a WTRU may be (pre)configured to receive a cell access broadcast channel that may be associated with detected and received synchronization signal(s) and may carry cell access information, e.g., a Physical Broadcast Channel (PBCH). A WTRU may be (pre)configured with a time and frequency multiplexing structure between a cell access broadcast channel, e.g., PBCH and associated synchronization signals, e.g., PSS and/or SSS. In one example, a 5G PBCH may be time and/or frequency multiplexed with the associated PSS and SSS.

A WTRU may receive a PBCH using the reference timing and frequency based on the detected and received synchronization signal(s). A WTRU may be (pre)configured to assume that the detected and received synchronization signal(s) and the associated PBCH may be Quasi-Co-located (QCL: ed), i.e., the synchronization signals and associated PBCH may be transmitted in the same downlink transmit beam and share the same cell access broadcast transmission index (e.g., SSB index). Accordingly, a WTRU may receive a PBCH using the same RX parameter(s), e.g., same RX beam as the ones used to detect and receive the synchronization signal(s).

A WTRU may receive a Demodulation Reference Signal (DMRS) sequence associated with the cell access channel to estimate channel for decoding of the cell access channel. A WTRU may be (pre)configured with a set of DMRS sequences using initialization and/or generation based on one or more input parameters. Each (pre)configured DMRS sequence may thus be associated with such parameter(s). In one example, a WTRU may be (pre)configured with a set of DMRS sequences associated with a PCI indicated by the synchronization signal(s). In another example, a WTRU may be (pre)configured with DMRS sequences associated with the time and/or frequency resource allocation in which a WTRU may detect and receive the associated synchronization signal(s). The time resource allocation may be indicated by an index of symbol, slot, sub-frame and/or frame. The frequency resource allocation may be indicated by an index of sub-carrier, RB, GSCN and/or ARFCN. Furthermore, a WTRU may be (pre)configured with PBCH DMRS sequences associated with any one or more of the following: an index to identify a cell access broadcast transmission, e.g., SSB index, a radio access technology (RAT) identifier, e.g., a 5G or 6G RAT, an indication to identify a 6G MRSS cell, and/or an indication to identity frame timing, e.g., a half-frame indication.

In another example, a WTRU may be (pre)configured with a scrambling sequence for cell access channel DMRS sequence. The scrambling sequence may be based on one or more above-discussed parameter(s).

A WTRU may identify a received cell access channel DMRS sequence by correlating the (pre)configured DMRS sequences and determine any one or more following information in addition to the channel estimation information: index of the received cell access broadcast transmission (e.g., SSB index), whether the cell to access may be a 5G cell, 6G cell or 6G MRSS cell, and/or timing of a radio frame. A WTRU may further decode and receive cell access broadcast channel based on DMRS-based channel estimation information.

For cell access information acquisition, a WTRU may decode and/or acquire the cell access information indicated in (pre)configured information fields in a received cell access broadcast channel, e.g., a PBCH. A WTRU may subsequently access the cell, e.g., obtain SIB1 information using the received cell access information. The cell access information may include one or more cell configuration parameter(s) including one or more of the following: System Frame Number (SFN), Sub-Carrier Spacing (SCS), SSB sub-carrier offset (Kssb), Demodulation Reference Signal (DMRS) type, downlink control channel (PDCCH) configuration for receive scheduling information (e.g. in DCI) of downlink data carrying cell system information (e.g., SIB1), cell access permission information, intra-frequency cell re-selection information, SSB identifier, and/or frame timing information.

With respect to System Frame Number (SFN), a WTRU may determine the SFN within which the WTRU may receive the cell access broadcast transmission. For example, a WTRU may receive a SFN comprised of 10 bits and ranging from 0 to 1023.

With regard to sub-Carrier Spacing (SCS), a WTRU may determine the SCS used for the transmission carrying cell system information, e.g., SIB1 information. A WTRU may determine the SCS based on this indication and/or the carrier frequency band of the received cell broadcast transmission. In one example, a WTRU may determine the SCS may be 15 kHz or 30 kHz when the carrier frequency band may be FR1. A WTRU may determine the SCS may be 15 kHz or 30 kHz when the carrier frequency band may be FR1 and 60 KHz or 120 KHz when the frequency band may be FR2.

With respect to the SSB sub-carrier offset (Kssb), a WTRU may determine the frequency domain resource allocation of a cell based on the indicated SSB sub-carrier offset and the frequency resource location of the receive cell access broadcast transmission. For example, a WTRU may determine the start of the frequency domain resource allocation of the cell may be the sum of the start of the frequency resource location of the received PSS, SSS and/or PBCH transmission and the indicated offset. The offset may be (pre)configured as number of sub-carriers, number of RBs and/or an absolute frequency value (e.g., kHz or MHz). A WTRU may determine the frequency resource scheduling information for a downlink and/or uplink data transmission based on the determined frequency domain resource allocation of the cell.

Regarding the Demodulation Reference Signal (DMRS) type, a WTRU may determine the position of DMRS associated with a scheduled downlink and/or uplink data transmission the cell.

With respect to downlink control channel (PDCCH) configuration for receive scheduling information (e.g. in DCI) of downlink data carrying cell system information (e.g., SIB1), a WTRU may determine the downlink control channel configuration including resource allocation and monitoring pattern based on the indicated downlink control channel configuration information. In one example, a WTRU may determine a control channel resource set (CORESET) and search space configuration for PDCCH reception of cell system information in SIB1 transmission. The abovementioned downlink control channel configuration may include any one or more the following parameter(s): bandwidth of the PDCCH transmission (e.g., an initial and/or default BWP), number of RBs/sub-carriers assigned for the PDCCH CORESET, number of symbols assigned for the PDCCH CORESET, multiplexing pattern between the received SSB transmission and the PDCCH transmission (e.g., a WTRU may be indicated with (pre)configured multiplexing pattern(s) in time and/or frequency domain. In one example, a (pre)configured multiplexing pattern may include an offset between the received SSB transmission and the PDCCH resource configuration. The offset may be indicated using a number of symbols, slots and/or sub-frames and/or a number of sub-carriers and/or RBs. In another example, a WTRU may be indicated with a SFN, sub-frame, slot and/or symbols of the PDCCH transmission and a center frequency of a CORESET), periodicity and time duration of a PDCCH search space (e.g., in one example, the periodicity and time duration may be indicated in the multiplexing pattern. The periodicity may be identical with the received SSB transmission), starting symbol of a PDCCH search space (e.g., in one example, the starting symbol may be indicated as a parameter in the indicated multiplexing pattern between the received SSB transmission and the PDCCH transmission), downlink control information (DCI) candidates and aggregation level (AL) (pre)configured for a PDCCH search space (e.g., in one example, a WTRU may be (pre)configured one or more DCI(s) and/or ALs associated with the indicated PDCCH search space. In another example, one or more DCI(s) and/or ALs associated with the indicated PDCCH search space may be indicated in the received PBCH), cell access permission information (e.g., a WTRU may determine whether the WTRU may be allowed to access the cell based on this information. In one example, a WTRU may be indicated the cell may be barred and the WTRU may accordingly not attempt to receive PDCCH and acquire the cell system information. A WTRU may be indicated the cell may not be barred and the WTRU may attempt to receive PDCCH and acquire the cell system information to access the cell), intra-frequency cell re-selection information (e.g., a WTRU may determine whether or not to perform cell selection/re-selection to different intra-frequency cells (i.e. cell transmitting on carriers in the same band) based on this indication when the cell with highest ranking in terms of SSB RSRP/RSSI may be barred and a WTRU may determine another cell to acquire cell system information), SSB identifier (e.g., a WTRU may determine an identifier, e.g., an index of a received SSB transmission. In one example, a WTRU may determine a SSB index based on a value indicated in the PBCH and/or a (pre)configured value associated with a received PBCH DMRS sequence. In one example, a WTRU may indicate a determined SSB identifier explicitly in reporting the SSB measurement to gNB. In another example, a WTRU may apply a determined SSB identifier to select one or more (pre)configured uplink transmission parameters including RACH occasion (RO), PRACH preamble and/or PUSCH scrambling sequence, etc.), and/or frame timing information (e.g., a WTRU may determine a frame timing (start of a radio frame) based on the frame timing indication in a received PBCH. In one example, a WTRU may receive an indication of half-frame, i.e. to indicate the received SSB transmission may be in the first or second half of a radio frame. The reason for the half-frame indication may be the SSB transmission may be (pre)configured in a 5-ms period and a WTRU may receive a SSB transmission in either half of a radio frame).

In some embodiments, a WTRU may determine one or more of the above-described cell access information from PBCH payload bits corresponding to higher layer configuration, e.g. cell access permission information and/or those corresponding to lower layer information, e.g., SSB index.

As will be discussed in more detail in the following, some embodiments may include or may be directed to WTRU reception of 6G cell access information based on reserved bits and/or re-used information fields in a received 5G SSB transmission.

In an embodiment, a WTRU may receive a 5G cell access broadcast transmission (e.g., on a cell access broadcast channel). For example, the 5G cell access broadcast transmission may be a 5G SSB and, in that case, the WTRU may detect and/or receive the 5G SSB.

In an embodiment, a WTRU may determine a 5G PCI. For example, the WTRU may detect a 5G PSS and/or SSS (e.g., included in the 5G SSB) and acquire time and frequency synchronization and the 5G PCI.

In an embodiment, a WTRU may determine that further 5G cell access information is received in the transmission. For example, the WTRU may determine the received cell access broadcast transmission (e.g., a 5G SSB) is a cell defining cell access broadcast transmission (e.g., CD-SSB). According to an embodiment, the WTRU may determine that the received cell access broadcast transmission (e.g., a 5G SSB) is a cell defining cell access broadcast transmission (e.g., CD-SSB) based on a value of an information field of SSB sub-carrier offset (K_{SSB}).

In an embodiment, a WTRU may determine that the cell access broadcast channel is carrying 6G cell access information, based on a spare or unused bit in the cell access broadcast channel. For example, the cell access broadcast channel may be a 5G PBCH and the WTRU may determine that the 5G PBCH is carrying 6G cell access information based on the spare or unused bit in the MIB in the decoded PBCH. As an example, the value of the spare or unused bit may indicate that the PBCH is carrying both 5G and 6G cell access information and/or the value of the spare or unused bit may indicate that 6G cell access information is included in the 5G SSB.

In an embodiment, a WTRU may determine the 6G cell access information based on the reserved bits and/or received 5G cell access information in the cell access broadcast channel (e.g., in the decoded PBCH). For example, the value (e.g., codepoints) of the reserved bits may indicate which 6G cell access information may be different from the corresponding received 5G cell access information (e.g., the 5G PDCCH CORESET/Search Space configuration).

Additionally or alternatively, a value of the reserved bits may indicate an offset from (e.g., relative to) the 5G cell access information, and the WTRU may determine the 6G cell access information based on the indicated offset from the 5G cell access information (e.g., a value of the reserved bits may indicate an adjustment of the decoded 5G PBCH information to obtain the equivalent 6G cell access information, e.g., an offset from the index (decoded in PDCCH configuration bit field) of the 5G PDCCH CORESET/Search Space configuration). Additionally or alternatively, the WTRU may determine the 6G cell access information based on a (pre-) configured offset that may be applied relative to the 5G cell access information. In other words, the WTRU may determine the indicated 6G cell access information based on the received 5G cell access information and a (pre-) configured offset (e.g., PDCCH configuration for 5G is indicated with a value X and 6G value will be X+offset). According to some embodiments, the WTRU may determine that the remaining 5G cell access information, e.g., SFN, SCS, SSB index, SSB sub-carrier offset, DMRS type are identical (or similar) to the 6G cell access information. Additionally or alternatively, a value of the reserved bits may indicate a 6G PCI (which may be the same as or an offset from the decoded 5G PCI). It is noted that Table 1 shown below illustrates examples of the codepoint(s) indicating a commonality between 6G cell access information and 5G cell access information carried in 5G cell access broadcast transmission (e.g., 5G SSB)

In an embodiment, a WTRU may receive 6G cell system information (e.g., SIB1) using the determined 6G cell access information.

As can be seen from the above, certain embodiments may use the 5G cell defining cell access broadcast transmission (e.g., 5G CD-SSB transmission) to indicate 6G cell access information by taking advantage of the potential deployment with all or most 6G cell access information being identical (or similar) between 5G and 6G MRSS cell. The benefits include network energy saving by reducing and/or turning off 6G cell access broadcast transmissions (e.g., 6G SSB transmissions).

Alternatively, instead of (or in addition to) 6G cell access information, the reserved bits in the cell access broadcast channel (e.g., PBCH) may indicate 6G cell access broadcast transmission information (e.g., 6G SSB transmission information), i.e., the 5G cell defining cell access broadcast transmission (e.g., 5G CD-SSB transmission) may indicate 6G cell access information or 6G cell access broadcast transmission information (e.g., 6G SSB transmission information).

As will be discussed in further detail below, some embodiments may include or may be directed to a WTRU determination of 6G cell access broadcast transmission information (e.g., 6G SSB transmission information) based on reserved bits and/or re-used information fields in a received 5G cell access broadcast transmission (e.g., 5G SSB transmission).

In an embodiment, a WTRU may detect and/or receive a 5G cell access broadcast transmission (e.g., 5G SSB). According to an embodiment, the WTRU may determine or acquire a 5G PCI based on the received cell access broadcast transmission. For example, the WTRU may detect synchronization signals (e.g., a 5G PSS and SSS) included in the 5G cell access broadcast transmission and may acquire time/frequency synchronization and/or a 5G PCI. In some embodiments, the WTRU may perform DMRS demodulation based on pre-defined sequences and/or may decode the corresponding 5G cell access broadcast channel (e.g., 5G PBCH).

In an embodiment, a WTRU may determine that further 5G cell access information is received in the transmission. For example, the WTRU may determine the received cell access broadcast transmission (e.g., a 5G SSB) is a cell defining cell access broadcast transmission (e.g., CD-SSB). According to an embodiment, the WTRU may determine that the received cell access broadcast transmission (e.g., a 5G SSB) is a cell defining cell access broadcast transmission (e.g., CD-SSB) based on a value of an information field of SSB sub-carrier offset (K_{SSB}).

In an embodiment, a WTRU may determine that the cell access broadcast channel is carrying 6G cell access information, based on a spare or unused bit in the cell access broadcast channel. For example, the cell access broadcast channel may be a 5G PBCH and the WTRU may determine that the 5G PBCH is carrying 6G cell access information based on the spare or unused bit in the MIB in the decoded PBCH. As an example, the value of the spare or unused bit may indicate that 6G cell access information is included in the 5G cell access broadcast transmission (e.g., 5G SSB).

In an embodiment, a WTRU may determine 6G cell access broadcast transmission information (e.g., 6G SSB transmission information) based on the reserved bits and/or unused information bits (e.g., PDCCH CORESET and Search Space configuration) in the cell access broadcast channel (e.g., in the decoded PBCH of the 5G NCD-SSB). For example, a value of the reserved bits and/or unused information bits may indicate any one or more of the following: timing and frequency resource (offset from received 5G SSB), periodicity, waveform, 6G PCI (e.g., same as or an offset from the decoded 5G PCI).

In an embodiment, a WTRU may detect and/or receive a 6G cell access broadcast transmission (e.g., 6G SSB) based on the received 6G cell access information. For example, the WTRU may be configured to apply QCL: ed relationship between the decoded 5G cell access broadcast transmission (e.g., 5G SSB) and the 6G cell access broadcast transmission (e.g., 6G SSB).

As can be seen from the above, certain embodiments may be configured to re-use the unused bits in the cell access broadcast channel (e.g., PBCH) associated with a 5G cell access broadcast transmission (e.g., 5G NCD-SSB transmission) to provide information for a 6G WTRU to detect and receive a 6G cell access broadcast transmission (e.g., 6G SSB transmission). The benefits include network energy saving using sparse 6G cell access broadcast transmissions (e.g., 6G SSB transmissions) and WTRU processing reduction and power saving with reduced search range for blind scanning and detection of 6G SSB transmission.

Alternatively, instead of (or in addition to) 6G cell access broadcast transmission information (e.g., 6G SSB transmission information), 6G cell access information may be indicated, e.g., 5G NCD-SSB indicates 6G SSB transmission information or 6G cell access information (e.g., MIB).

As will be discussed in detail below, some embodiments may include or may be directed to a WTRU performing a transmission to request 6G cell access broadcast transmission (e.g., 6G SSB transmission) according to the request transmission information indicated in reserved bits and/or re-used information fields in a received 5G cell access broadcast transmission (e.g., 5G SSB transmission).

In an embodiment, a WTRU may detect and/or receive a 5G cell access broadcast transmission (e.g., 5G SSB). According to an embodiment, the WTRU may determine or acquire a 5G PCI based on the received cell access broadcast transmission. For example, the WTRU may detect synchronization signals (e.g., a 5G PSS and SSS included in the 5G cell access broadcast transmission) and may acquire time/frequency synchronization and/or a 5G PCI. In some embodiments, the WTRU may perform DMRS demodulation based on pre-defined sequences and/or may decode the corresponding 5G cell access broadcast channel (e.g., 5G PBCH).

In an embodiment, the WTRU may determine the received cell access broadcast transmission (e.g., a 5G SSB) is a cell defining cell access broadcast transmission (e.g., CD-SSB). According to an embodiment, the WTRU may determine that the received cell access broadcast transmission (e.g., a 5G SSB) is a non-cell defining cell access broadcast transmission (e.g., NCD-SSB) based on a value of an information field of SSB sub-carrier offset (K_{SSB}).

In an embodiment, a WTRU may determine that the 5G cell access broadcast channel (e.g. 5G PBCH) is carrying information for a 6G cell access broadcast transmission (e.g., 6G SSB transmission) request, based on a spare or unused bit in the cell access broadcast channel. For example, the cell access broadcast channel may be a 5G PBCH and the WTRU may determine that the 5G PBCH is carrying information for a 6G cell access broadcast transmission (e.g., 6G SSB transmission) request, based on the spare or unused bit in the MIB in the decoded PBCH. As an example, the value of the spare or unused bit may indicate the WTRU to transmit a request according to the information indicated in the 5G cell access broadcast channel (e.g., PBCH).

In an embodiment, a WTRU may determine 6G cell access broadcast transmission (e.g., 6G SSB transmission) request configuration based on the reserved bits and/or unused information bits (e.g., PDCCH CORESET and Search Space configuration) in the decoded cell access broadcast channel (e.g., PBCH) of the 5G non-cell defining cell access broadcast transmission (e.g., 5G NCD-SSB). For example, the 6G cell access broadcast transmission (e.g., 6G SSB transmission) request configuration may include any one or more of the following: SCS, timing and frequency resource (offset from received 5G SSB), waveform, TCI state, transmit power, and/or 6G PCI.

In an embodiment, a WTRU may perform a 6G cell access broadcast transmission (e.g., 6G SSB transmission) according to the determined cell access broadcast transmission request configuration.

As will be discussed in more detail below, some embodiments may include or may be directed to WTRU detection and/or reception of 6G cell access broadcast transmission (e.g., 6G SSB transmission) associated with 5G synchronization signal transmission (e.g., 5G PSS and SSS transmission).

In an embodiment, a WTRU may detect and/or receive 5G synchronization signal(s) (e.g., a 5G PSS and SSS), and may acquire time and frequency synchronization and/or determine a 5G PCI.

In an embodiment, a WTRU may determine a 6G cell access broadcast transmission (e.g., 6G SSB) search range (time and frequency) based on the 5G synchronization signal(s) (e.g., 5G PSS/SSS) timing, GSCN and/or the 5G PCI. For example, there may be a pre-configured association between 5G synchronization signal(s) (e.g., 5G PSS/SSS) timing, GSCN and/or 6G cell access broadcast transmission (e.g., 6G SSB) time and frequency resource range (e.g., the association can be a time offset and/or frequency raster offset from the detected 5G PSS and SSS). The 6G PCI may be the same as 5G PCI or with a pre-configured offset (from or relative to the 5G PCI).

In an embodiment, a WTRU may search and/or detects 6G cell access broadcast transmission (e.g., 6G SSB) in the indicated time and frequency resources. The DMRS sequence may be scrambled with the determined 6G PCI. The WTRU may apply QCL: ed relationship between the decoded 5G synchronization signal(s) (e.g., 5G PSS/SSS) and 6G cell access broadcast transmission (e.g., 6G SSB transmissions).

In an embodiment, a WTRU may receive 6G cell access broadcast channel (e.g., 6G PBCH) information from the 6G cell access broadcast transmission (e.g., 6G SSB transmission).

In view of the above, certain embodiments may re-use 5G PSS/SSS transmissions with pre-configured association to indicate 6G cell access broadcast transmission, e.g., a 6G SSB. The benefits include network energy saving by reducing the synchronization transmissions for 6G SSBs in a 6G MRSS cell. In network planning for a 6G MRSS cell, the 6G SSB transmissions may be placed in time and frequency resources associated with that of 5G SSB transmission.

As will be discussed in more detail below, some embodiments may include or may be directed to WTRU acquisition of 6G cell access information based on detected 6G broadcast indication transmission.

In an embodiment, a WTRU may detect and/or receive a 6G synchronization signal transmission and acquire time and frequency synchronization and a PBCIH indication (e.g., a pre-configured dedicated synchronization signal). The GSFN may be pre-configured for 6G MRSS cell.

In an embodiment, a WTRU may determine the 6G synchronization signal transmission is associated with a broadcast indication transmission based on indication in a supplementary and/or secondary SSB transmission.

In an embodiment, a WTRU may receive the supplementary/secondary SSB transmission using DMRS sequence determination based on SSB identifier and supplementary/secondary SSB transmission indication.

In an embodiment, a WTRU may receive any one or more of the following information for a 6G cell access broadcast channel transmission (e.g., a 6G CD-SSB) in the decoded broadcast indication transmission (e.g. an index to a pre-configured table): timing and frequency resource (e.g., relative offset), periodicity of 6G CD-SSB transmission, waveform used for 6G CD-SSB transmission, 6G PCI, and/or request indication.

In an embodiment, a WTRU may detect and/or receive a 6G cell access broadcast channel based on the received 6G cell access channel information. For example, a WTRU may apply QCL: ed relationship between the broadcast indication and 6G SSB transmissions.

As can be seen from the above, certain embodiments can enable more frequent 6G broadcast indication transmissions with a much smaller payload of information regarding the sparser 6G cell access broadcast transmission (e.g., CD-SSB). It may serve the same purpose of a 5G NCD-SSB transmission such as time and frequency synchronization, measurement and monitoring. Additionally, the new information may assist a WTRU to detect a sparse CD-SSB without excessive WTRU processing. The benefits are a balanced tradeoff between network energy saving (reduced/turn-off 6G CD-SSB transmissions) and WTRU cell search performance (more detection of indication transmissions to assist CD-SSB acquisition).

As will be discussed in more detail below, some embodiments may include or may be directed to WTRU determination of supplementary and/or secondary 6G cell access from a 6G cell access broadcast transmission (e.g., 6G SSB transmission) based on information fields in a received default and/or primary 6G cell access broadcast transmission (e.g., 6G SSB transmission).

In an embodiment, a WTRU may detect and/or receive a default 6G cell access broadcast transmission (e.g., 6G SSB). For example, the WTRU may detect a 6G PSS and SSS and acquire time and frequency synchronization. The WTRU may perform DMRS demodulation based on pre-defined sequences and decodes the corresponding 6G PBCH. The WTRU may determine a primary PCI from the decoded default SSB.

In an embodiment, a WTRU may receive default cell access information in a default and/or primary SSB transmission. The default SSB transmission may be indicated in the PBCH or PBCH DMRS. The default cell access information may include, for example, SFN, SCS, SSB offset, and/or DMRS type.

In an embodiment, a WTRU may receive supplementary cell access information in a supplementary and/or secondary SSB transmission. The supplementary/secondary SSB transmission may be indicated in the PBCH or PBCH DMRS. The supplementary cell access information may include, for example, any one or more of the following: secondary/non-default SSB structure (e.g. periodicity, PSS/SSS sequencies, transmit power, SSB resource allocation), a supplementary 6G PCI (e.g., which may be the same as or an offset from the decoded default PCI), and/or additional information needed to receive associated 6G cell system information (SIB1). For example, the additional information may include an explicit indication to indicate an adjustment of the decoded default cell access information to determine the supplementary cell access information, e.g., an offset from the index of PDCCH configuration received in the default SSB to determine the PDCCH configuration of the cell. Additionally or alternatively, the additional information may include an explicit value indication to indicate additional parameters, e.g., a PCI of the cell.

In an embodiment, a WTRU may receive 6G cell system information (e.g. SIB1) using the determined cell access information.

In view of the above, certain embodiments can allow the network to avoid broadcast cell access information for every 6G cell (e.g., especially small cells saving energy). Within a given cell, some embodiments may allow the WTRU to determine secondary SSB structures within the cell.

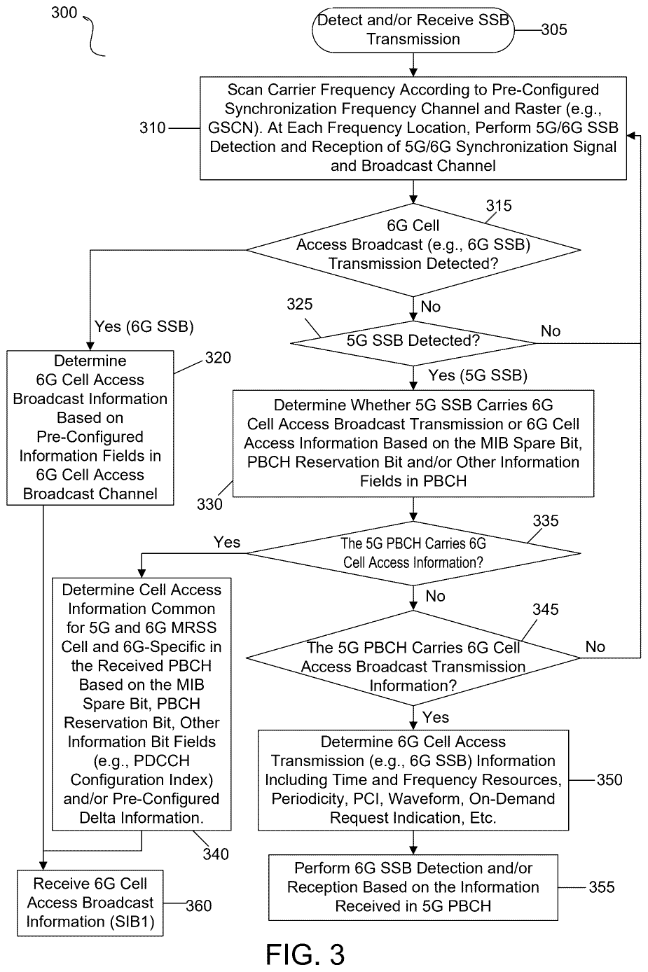

FIG. 3 illustrates an example flow diagram of a method 300 for or relating to detection and/or reception of 5G and/or 6G cell access information (e.g., MRSS cell access broadcast information), according to some embodiments. The example method 300 of FIG. 3 and accompanying disclosures herein may include, may be based on, or may be a synthesization of various embodiments or elements discussed in detail above.

For convenience and simplicity of exposition, the example of FIG. 3 may be described with reference to the architecture or system described above with respect to FIGS. 1A-1D, for instance. However, the example method 300 depicted in FIG. 3 may be carried out using different architectures as well. According to some embodiments, the method 300 of FIG. 3 may be performed or implemented by a UE or WTRU, such as the WTRU 102 described in the foregoing.

It is noted that the method 300 of FIG. 3 may include further steps, procedures or details as discussed in detail elsewhere in this disclosure. As such, the method 300 of FIG. 3 may be modified to include any of the steps, procedures, elements and/or details illustrated and/or discussed in the foregoing.

Moreover, it is noted that the method and/or blocks of FIG. 3 may be modified to include, or to be replaced by, any one or more of the procedures, elements or blocks discussed elsewhere herein. As such, one of ordinary skill in the art would understand that FIG. 3 is provided as one example and modifications thereto are possible while remaining within the scope of certain example embodiments.

As illustrated in the example of FIG. 3, the method 300 may include, at 305, detecting and/or receiving a SSB transmission.

In an embodiment, the method 300 may include, at 310, scanning carrier frequency according to pre-configured synchronization frequency channel and raster (e.g., GSCN) and/or, at each frequency location, performing 5G/6G SSB detection and/or reception of 5G/6G synchronization signal and broadcast channel.

In an embodiment, the method 300 may include, at 315, determining if 6G cell access broadcast (e.g., 6G SSB) transmission detected. If a 6G cell access broadcast transmission is detected, then the method 300 may include, at 320, determining 6G cell access broadcast information based on pre-configured information fields in a 6G cell access broadcast channel. The method 300 may then include, at 360, receiving 6G cell access broadcast information (e.g., SIB1).

If it is determined a 6G cell access broadcast transmission is not detected at 315, then the method 300 may include, at 325, determining whether a 5G cell access broadcast (e.g., 5G SSB) transmission is detected. If a 5G cell access broadcast (e.g., 5G SSB) transmission is not detected, then the method 300 may return to block 310 discussed above. If it is determined that a 5G cell access broadcast (e.g., 5G SSB) transmission is detected, then the method 300 may include, at 330, determining whether 5G SSB carries 6G cell access broadcast transmission or 6G cell access information based on a spare or unused bit (e.g., the MIB spare bit), a reserved bit (e.g., PBCH reservation bit) and/or other information fields in a cell access broadcast channel (e.g., PBCH).

In an embodiment, the method 300 may include, at 335, determining whether the 5G cell access broadcast channel (e.g., PBCH) carries 6G cell access information. If it is determined that the 5G cell access broadcast channel (e.g., PBCH) does carry 6G cell access information, the method 300 may include, at 340, determining cell access information common for 5G and 6G MRSS cell and 6G-specific cell access information in the received cell access broadcast channel (e.g., PBCH) based on the spare or unused bit (e.g., the MIB spare bit), reserved field (e.g., PBCH reservation bit), other information bit fields (e.g., PDCCH configuration index) and/or pre-configured delta information. The method 300 may then include, at 360, receiving 6G cell access broadcast information (e.g., SIB1).

If it is determined at 335 that the 5G cell access broadcast channel (e.g., PBCH) does not carry 6G cell access information, the method 300 may include, at 345, determining whether the 5G cell access broadcast channel (e.g., PBCH) carries 6G cell access broadcast transmission information. If it is determined at 345 that the 5G cell access broadcast channel (e.g., PBCH) does not carry 6G cell access broadcast transmission information, the method 300 may return to block 310 discussed above.

If it is determined at 345 that the 5G cell access broadcast channel (e.g., PBCH) does carry 6G cell access broadcast transmission information, the method 300 may include, at 350, determining 6G cell access transmission (e.g., 6G SSB) information including any of time and/or frequency resources, periodicity, PCI, waveform, and/or on-demand request indication, etc.

In an embodiment, the method 300 may include, at 355, performing 6G cell access transmission (e.g., 6G SSB) detection and/or reception based on the information received in the 5G cell access broadcast channel (e.g., PBCH).

It is noted that the flow diagram illustrated in FIG. 3 is provided as one example, and modifications thereto are contemplated according to certain embodiments as discussed elsewhere herein. For example, one or more of the steps illustrated in FIG. 3 may be omitted, combined, modified and/or performed in a different order, as provided in the example embodiments discussed herein. Additional detail regarding the various procedures illustrated in the example of FIG. 3 is discussed below.

As introduced above, certain embodiments may be directed to methods for UE cell access based on 5G cell access broadcast transmissions (e.g., SSB transmissions). For example, some embodiments may include WTRU determination and/or reception of 6G cell access information in a 5G cell access broadcast transmission (e.g., 5G SSB transmission).

According to an embodiment, a WTRU may detect and/or receive a 5G cell access broadcast transmission (e.g., 5G SSB transmission). For example, the 5G cell access broadcast transmission (e.g., 5G SSB transmission) may be received at a frequency location denoted by a GSCN. A WTRU may acquire time and frequency synchronization and a 5G PCI based on the received synchronization sequences (e.g., PSS and/or SSS sequences). A WTRU may receive a cell access broadcast channel (e.g., 5G PBCH) within the received 5G cell access broadcast transmission (e.g., 5G SSB transmission).

Some embodiments may include WTRU determination of the presence of cell access information of a 6G cell in a 5G cell access broadcast transmission (e.g., in a 5G SSB transmission), based on indication(s) received in the cell access broadcast channel (e.g., PBCH).

In an embodiment, a WTRU may determine a received cell access broadcast channel (e.g., 5G PBCH) may include cell access information of a 6G cell based on a 6G cell access information indication field in the received 5G cell access broadcast channel (e.g., 5G PBCH). A WTRU may be (pre)configured with a 6G cell access information indication to indicate the presence of 6G cell access information in a cell access broadcast channel (e.g., 5G PBCH). The 6G cell access information indication may be (pre)configured as any one or more of the following
An indication using one or more (pre)configured reserved/spare/unused/repurposed information field(s)/bit(s) in cell access information indicated by higher layer, e.g., a spare bit in a 5G master information block (MIB) transmitted in a 5G PBCH.
An indication using the (pre)configured reserved/spare/unused information field(s)/bit(s) in PBCH payload indicated by lower layer. In one example, a WTRU may be (pre)configured a number of reserved bit(s) in a SSB index indication in PBCH and a WTRU may determine the available reserved bits based on the carrier frequency of a received SSB transmission. A WTRU may determine a 6G cell access information indication using two reserved bits when the carrier frequency of the received SSB transmission may be below 3 GHz. A WTRU may determine a 6G cell access information indication using one reserved bit when the carrier frequency of the received SSB transmission may be between 3 GHz and 6 GHz. A WTRU may determine a 6G cell access information indication may not be present in the SSB index indication when the carrier frequency of the received SSB transmission may be above 6 GHZ.
An indication using (pre)configured reserved/unused codepoint(s) in information field(s) in PBCH, i.e. codepoint(s) not applied for 5G cell access information. In one example, a WTRU may determine 6G cell access information may be present in the PBCH based on one or more reserved/unused codepoint(s) indicated in the PDCCH CORESET information field. The reserved/unused codepoint(s) may be (pre)configured based on carrier frequency, SCS of the received SSB transmission and/or PDCCH SCS indicated in the PBCH.

A 5G WTRU may not attempt to decode (pre)configured reserved/spare/unused information field(s)/bit(s) in MIB and/or lower layer-generated payload in a received 5G PBCH. A 5G WTRU may not expect to receive a (pre)configured reserved/unused codepoint(s) in decoded information fields/bit(s) in a received 5G PBCH.

A WTRU may determine based on the above-mentioned indications that 6G cell access information may not be present in a received cell access (e.g., 5G SSB) transmission. In this case, a WTRU may discard the received cell access (e.g., 5G SSB) transmission and attempt to detect and receive another 5G and/or 6G cell access (e.g., SSB) transmission.

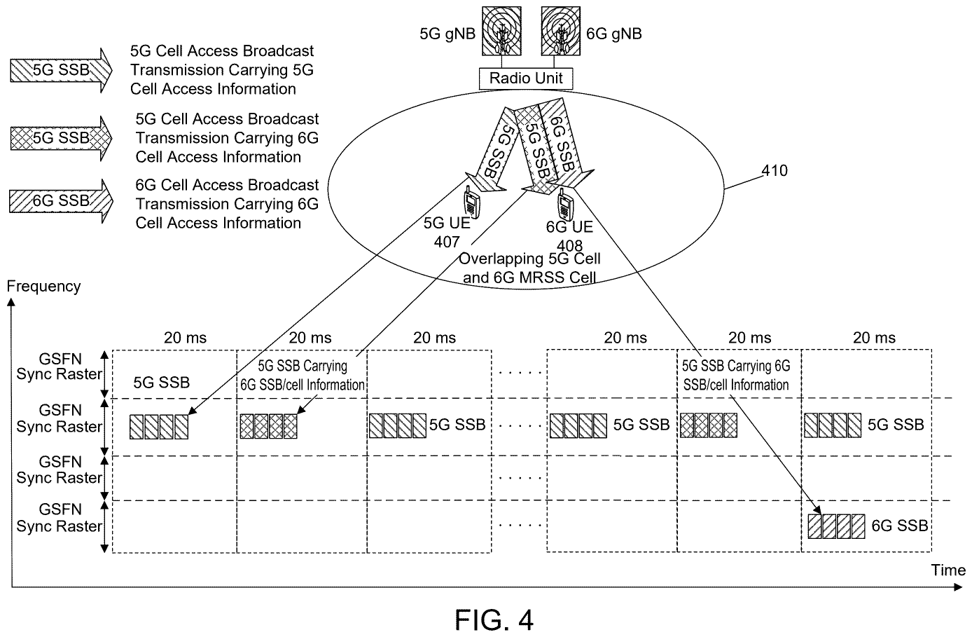

FIG. 4 illustrates an example of cell access broadcast transmissions in a 5G/6G MRSS cell, according to certain embodiments. As depicted in the example of FIG. 4, a WTRU 407 (e.g., 5G UE) and/or WTRU 408 (e.g., 6G UE) may detect and receive a 5G SSB transmission carrying 6G cell access information. In an overlapping coverage of a 5G cell and 6G MRSS cell 410, WTRU 408 may detect and/or receive more frequent 5G SSB transmissions and receive 6G cell access information in one or more 5G SSB transmissions. This may enable a very sparse 6G SSB transmission for network energy saving.

Some embodiments may include or may be directed to WTRU determination of system access information of a 6G cell in a 5G cell access broadcast (e.g., SSB) transmission identified in higher layer signaling.

In an embodiment, a WTRU may determine a received 5G cell access broadcast (e.g., SSB) transmission may include cell access information of a 6G cell based on one or more of the following received in higher layer configuration signaling, e.g., MAC and RRC signaling: an indication to identify a cell access broadcast (e.g., SSB) transmission, e.g., identifier(s) of a 5G SSB transmission that may include 6G cell access information. A WTRU may be (pre)configured with identifiers including one or more of the following properties of a 5G SSB transmission: PCI, time resource allocation (e.g., starting symbol, slot, sub-frame, SFN, etc.), frequency resource allocation (e.g., GSCN, ARFCN, carrier frequency, RB index, etc.), PBCH DMRS sequence index, SSB index, and/or TCI state. For example, a WTRU may determine the indicated 5G cell access broadcast (e.g., SSB) transmission may be QCL: ed with the downlink reference signal indicated in the TCI state. A WTRU may thus detect and receive the indicated 5G cell access broadcast (e.g., SSB) transmission using a receive spatial filter configuration corresponding to the indicated TCI state. In one example, a WTRU may be (pre)configured with an indication of resource allocated for a cell access broadcast (e.g., SSB) transmission, e.g., an index that may denote (pre)configured time and/or frequency resources, i.e., SSB resource indication (SRI). An SRI may indicate necessary information to detect a SSB transmission.

According to an embodiment, a WTRU may detect and receive 5G cell access broadcast (e.g., SSB) transmission(s) within the indicated time and frequency resources. A WTRU may further determine the indicated 5G cell access broadcast (e.g., SSB) transmission(s) may be received when one or more indicated parameters, properties, and/or characteristics of the received cell access broadcast (e.g., SSB) transmission may be identical with the corresponding parameters, properties, and/or characteristics indicated higher layer signaling. In one example, a WTRU may determine an indicated 5G cell access broadcast (e.g., SSB) transmission may be received when the 5G cell access broadcast (e.g., SSB) transmission may be received at indicated time and frequency resource allocation and the 5G PCI may be identical with the indicated PCI. In another example, a WTRU may determine an indicated 5G cell access broadcast (e.g., SSB) transmission may be received when the WTRU may detect and receive the 5G cell access broadcast (e.g., SSB) transmission in resource(s) indicated by the SRI. A WTRU may determine the received 5G cell access broadcast (e.g., SSB) transmission may include 6G cell access information when the WTRU may determine the 5G cell access broadcast (e.g., SSB) transmission indicated in the higher layer configuration may be detected and received.

Some embodiments may include or may be directed to a WTRU determination of cell access information of a 5G cell in a 5G cell access broadcast (e.g., SSB) transmission based on indication(s) received in a cell access broadcast channel (e.g., PBCH).

According to an embodiment, a WTRU may be (pre)configured with a 5G cell access information indication to indicate the presence of 5G cell access information in a cell access broadcast channel (e.g., PBCH). A WTRU may apply the indicated 5G cell access information to decode 5G PDCCH to receive 5G system information in SIB1 transmission. A WTRU may determine 5G cell access information (e.g., the PDCCH configuration) may be included in a received 5G cell access broadcast channel (e.g., PBCH) based on one or more of the following indicated in the received broadcast channel (e.g., PBCH): an indication using (pre)configured codepoint(s) in information field(s) in the broadcast channel (e.g., PBCH). In one example, a WTRU may be (pre)configured with one or more codepoint(s) indicated in SSB sub-carrier offset information field in the broadcast channel (e.g., PBCH).

In an embodiment, a WTRU may determine the received 5G cell access broadcast transmission (e.g., SSB) may be a 5G CD-SSB. When a WTRU may not receive the 5G cell access information indication in a received broadcast channel (e.g., PBCH), the WTRU may determine the received cell access broadcast transmission (e.g., SSB transmission) may be a 5G NCD-SSB. In one example, the SSB offset (K_{ssb}) may be (pre)configured to indicate whether the 5G broadcast channel (e.g., PBCH) may carry information to acquire 5G SIB1, i.e., associated with SIB1 transmission (CD-SSB) or carry no SIB1 information, i.e. not associated with SIB1 transmission (NCD-SSB). An SSB offset value may correspond to n bits (e.g. 4 bits for FR2 or 5 bits for FR1) and indicate whether or not the SSB has an associated SIB1 transmission. For example, when the SSB offset value are in range (e.g. <=23 for FR1 or <=11 for FR2), the WTRU may determine a corresponding SIB1 information is present in the received 5G broadcast channel (e.g., PBCH). When the SSB offset value is out of range (e.g. >23 for FR1 or >11 for FR2), the WTRU may assume the SIB1 information is absent. In another example, when SIB1 information is determined to be absent in a received 5G broadcast channel (e.g., PBCH), the WTRU may determine (pre)configured bit-field(s) in the received 5G broadcast channel (e.g. bit-fields associated with PDCCH configuration) may be re-used and/or repurposed and/or point to the locations of the nearest 5G and/or 6G cell access broadcast (e.g., SSB) transmissions that may include SIB1 information. The indicated locations with associated SIB1 may correspond to any of the locations in frequency, time or spatial domains, for example.

A 5G WTRU may disregard the received PDCCH configuration information field in a received NCD-SSB transmission. In one example, a WTRU may be indicated with (pre)configured reserved codepoint(s) in the PDCCH configuration information field that 6G cell access information may be present in the 5G NCD-SSB transmission.

Some embodiments may include or may be directed to WTRU determination of system access information of 6G cell based on a received system access information of a 5G cell in a 5G cell access broadcast (e.g., SSB) transmission.

In an embodiment, upon determination of the presence of 6G cell access information in a received 5G broadcast channel (e.g., PBCH) transmission, a WTRU may further determine the content of the 6G cell access information. In one embodiment, a WTRU may determine that the received cell access information may apply to the 5G and 6G cell when the presence of 6G cell access information may be indicated in the received broadcast channel (e.g., PBCH). In this case, the cell access information including, e.g., SFN, SCS, SSB sub-carrier offset, DMRS type, PDCCH configuration, cell access permission information, intra-frequency cell re-selection information, SSB index and/or frame timing information may be identical between the 5G and 6G cell. In one example, a WTRU may be (pre)configured a 6G cell access information indication using a spare bit in 5G MIB. The WTRU may determine cell access information of two cells of different RATs (e.g., different types of RATs or different RAT types) may be received and, in addition, the cell access information of both cells may be identical as indicated in a 5G broadcast channel (e.g., PBCH) based on any of the following: determine a 5G CD-SSB may be received as discussed above regarding WTRU determination of cell access information of a 5G cell in a 5G cell access broadcast (e.g., SSB) transmission based on indication(s) received in the broadcast channel (e.g. PBCH) and cell access information of a 5G cell may be received, and/or determine that 6G cell access information may be present and identical to the 5G cell access information received in the 5G broadcast channel (e.g., PBCH) as indicated in 6G cell access information indication.

In an embodiment, a WTRU may determine the presence and content of 6G cell access information based on received indication using a combination of one or more (pre)configured reserved, spare, and/or unused information field(s) or bit(s) in cell access information indicated by higher layer and (pre)configured reserved/spare/unused information field(s)/bit(s) in broadcast channel (e.g., PBCH) payload indicated by lower layer. In one example, a WTRU may be (pre)configured with an indication of 6G cell access information presence using a spare bit in 5G MIB and an indication of 6G-specific cell access information content using reserved bit(s) in broadcast channel (e.g., PBCH) payload indicated by lower layer. The codepoints of the 6G-specific cell access information content indication bit-field (e.g., two codepoints using one reserve bit and four codepoints using two reserved bits) may be (pre)configured to indicate which cell access information indicated in the received PBCH may be different between a 5G and 6G cell.

In an embodiment, the UE may determine the contents of 6G cell access information, related to the PDCCH configuration for receiving 6G SIB1, based on the combination of the spare bit(s) in any of 5G MIB and broadcast channel (e.g., PBCH) payload. In this case, the spare bit(s) in the 5G MIB and/or broadcast channel (e.g., PBCH) payload may be used to extend the 5G PDCCH configuration to provide additional entries and/or indexes corresponding to the 6G PDCCH configuration, which may include the search space zero and CORESET zero for receiving the PDCCH associated with the 6G cell system info (SIB1 of 6G cell). Alternatively, the WTRU may infer from the presence of spare bit in 5G MIB indicating a value of ‘1’ to use an alternative PDCCH configuration that may be preconfigured/predefined to provide a different search space zero and CORESET zero for accessing the 6G cell system information.

In one example discussed in Table 1 below, a WTRU may be (pre) configure with the value of the 6G cell access information presence indication (e.g., codepoint of 1 as described in column 1 in Table 1) using the spared bit in MIB to indicate the presence of 6G cell access information in a 5G broadcast channel (e.g., PBCH). Also, a WTRU may be (pre)configured with a set of codepoints of 6G cell access information content indication using the reserved bit in the broadcast channel (e.g., PBCH) to indicate the content of 6G-specific cell access information in a 5G broadcast channel (e.g., PBCH).

When one reserve bit may be applied, a 6G cell access information content indication of codepoints 0 may be (pre)configured to indicate the 6G cell access information may be identical to the 5G cell access information indicated in the 5G broadcast channel (e.g., PBCH). The codepoints of 1 of this indication may be (pre)configured to be correspond to a cell access information, e.g., PDCCH configuration (as in column 2 in Table 1) and what the corresponding 6G cell access information may be, e.g., a fixed and (pre)configured PDCCH configuration. In another example, the codepoints of 1 may indicate a (pre)configured relative configuration index offset. A WTRU may determine the index of 6G PDCCH configuration as a function of the (pre)configured index offset and the indicated index of the 5G PDCCH configuration in a received 5G broadcast channel (e.g., PBCH), e.g., a sum of both.

When two reserve bits may be applied, a 6G cell access information content indication of codepoints 0 may be (pre)configured to indicate the 6G cell access information may be identical to the 5G cell access information indicated in the 5G broadcast channel (e.g., PBCH). The codepoints of 1, 2 and 3 of this indication may be (pre)configured to correspond to three different 5G cell access information indicated in a 5G broadcast channel (e.g., PBCH), e.g., PDCCH configuration, SCS configuration and cell permission information (as in column 3 in Table 1), respectively. In addition, a codepoint (e.g., each codepoint) may indicate a fixed and (pre)configured corresponding 6G cell access information, e.g., PDCCH configuration and SCS. In another example, the indication may indicate a (pre)configured relative configuration index offset. A WTRU may determine the index (pre)configured to corresponding 6G PDCCH configuration and SCS configuration as a function (e.g., sum) of the (pre)configured index offset and the indicated index of the 5G PDCCH configuration and/or SCS configuration in a received 5G broadcast channel (e.g., PBCH). In a further example, when a codepoint may correspond to a Boolean indication of cell access information, e.g., cell access permission information, a WTRU may determine the corresponding 6G cell access information may be the opposite to what may be indicated in the received broadcast channel (e.g., PBCH).

In an embodiment, a WTRU may be (pre)configured with a set of 6G cell access information configuration and the cell access information configuration (e.g., each information configuration) may include the indications (e.g., all indications) included in a broadcast channel (e.g., PBCH). A 6G cell access information configuration may be (pre)configured with 6G-specific information and indicated with an index. A WTRU may determine 6G-specific cell access information corresponding to the index indicated in 6G cell access information content indication in a received 5G PBCH. In an embodiment, the set of 6G cell access information may be (pre)configured with an association with one or more information indicated in the 5G broadcast channel (e.g., PBCH). For example, a WTRU may be (pre)configured with a set of 6G cell access information configurations associated with SCS. A WTRU may first determine the set of 6G cell access information configurations corresponding to the SCS indicated in a received broadcast channel (e.g., PBCH) and further determine the 6G cell access information configuration corresponding to the index indicated in 6G cell access information content indication in a received 5G broadcast channel (e.g., PBCH).

TABLE 1
Example of 6G cell access information content indication

| codepoints of 6G cell | | |
|---|---|---|
| access information | | |
| presence indication | codepoints of 6G cell access | codepoints of 6G cell access |
| (e.g., spare bit in | information content indication | information content indication |
| MIB) | (e.g., one reserve bit in PBCH) | (e.g., two reserve bits in PBCH) |
| 1 (present) | 0 (all 6G cell access information | 0 (all 6G cell access information |
| | Identical with 5G cell access | Identical with 5G cell access |
| | information indicated in the | information indicated in the PBCH) |
| | PBCH) | |
| | 1 (6G PDCCH configuration | 1 (6G PDCCH configuration |
| | different from the indicated 5G | different from the indicated 5G |
| | PDCCH configuration or pre- | PDCCH configuration) |
| | configured 6G system access | |
| | information) | |
| | N/A | 2 (6G SCS configuration different |
| | | from the indicated 5G SCS) |
| | N/A | 3 (cell access permission |
| | | information from the indicated 5G |
| | | cell access permission information) |
| 0 (not present) | N/A | N/A |

Thus, in certain embodiments, a WTRU may determine 6G cell access information in a 5G cell access broadcast (e.g., SSB) transmission based on the indicated 5G cell access information in the received broadcast channel (e.g., PBCH) and 6G-specific cell access information indicated by the 6G cell access content indication.

Some embodiments may include or may be directed to WTRU determination of 6G PCI associated with 6G system access information received in a 5G cell access broadcast transmission (e.g., SSB transmission).

According to an embodiment, a WTRU may determine a 5G PCI based on the synchronization signal(s) (e.g., PSS and SSS) transmissions received in a 5G cell access broadcast (e.g., SSB) transmission. A WTRU may further determine a 6G PCI of the 6G cell of which the cell access information may be received. In an embodiment, a WTRU may determine that a 6G PCI may be identical with the 5G PCI determined based on the received 5G cell access broadcast (e.g., SSB) transmission. In an embodiment, a WTRU may be (pre)configured with a 6G PCI indication in the 5G broadcast channel (e.g., PBCH) using reserved bit(s) in the broadcast channel (e.g., PBCH) payload indicated by lower layer. A codepoint (e.g., each codepoint) of the indication field (e.g., two codepoints using one reserve bit and four codepoints using two reserved bits) may be (pre)configured to indicate a PCI offset. A WTRU may determine a 6G PCI as a function (e.g., sum) of the 5G PCI indicated in the received cell access broadcast (e.g., SSB) transmission and the indicated offset. In an embodiment, a WTRU may determine a 6G PCI as a function (e.g., a sum) of a 5G PCI determined based on the received 5G cell access broadcast (e.g., SSB) transmission and a (pre)configured PCI offset.

Some embodiments may include or may be directed to WTRU determination of 6G cell access information indicated in a received 5G cell access broadcast (e.g., SSB) transmission.

In an embodiment, a WTRU may determine 6G cell access information of two cells of different RATs (e.g., different types of RATs or different RAT types) may be received and further determine the content of 6G cell access information in accordance with any of the following examples.

In an example, a WTRU may determine a 5G CD-SSB may be received as discussed above regarding WTRU determination of cell access information of a 5G cell in a 5G cell access broadcast (e.g., SSB) transmission based on indication(s) received in a broadcast channel (e.g., PBCH) and cell access information of a 5G cell may be received.

In an example, a WTRU may determine 6G cell access information may be present in the received 5G broadcast channel (e.g., PBCH) based on indication of a (pre)configured codepoint at the spared bit in the received 5G MIB. For example, codepoint 1 may be (pre)configured to indicate the presence and 0 to indicate otherwise.

In an example, a WTRU may determine which 5G cell access information indication in the received 5G broadcast channel (e.g., PBCH) may not apply to 6G cell and furthermore the corresponding 6G cell access information content based on (pre)configured codepoint(s) of the reserved bits in the broadcast channel (e.g., PBCH) payload indicated by lower layer. Examples of codepoint(s) and corresponding 6G cell access information may be indicated in Table 1.

In an example, a WTRU may determine a 6G PCI as discussed above regarding WTRU determination of a 6G PCI associated with 6G system access information received in a 5G cell access broadcast (e.g., SSB) transmission.

In an example, a WTRU may determine the rest of 6G cell access information may be identical with the corresponding 5G cell access information received in the 5G broadcast channel (e.g., PBCH).

According to some embodiments, a WTRU may be configured to perform a transmission to request for 6G SSB transmission based on an indication in a received 5G SSB transmission.

In an embodiment, a WTRU may detect and receive a 5G cell access broadcast (e.g., SSB) transmission at a frequency location denoted by a GSCN. A WTRU may acquire time and frequency synchronization and a 5G PCI based on the received synchronization (e.g., PSS and SSS) sequences. A WTRU may receive a 5G broadcast channel (e.g., PBCH) within the received 5G cell access broadcast (e.g., SSB) transmission (e.g., a WTRU may receive SSB transmission(s) on a PBCH). A WTRU may acquire 5G cell access information including, e.g., SFN, SCS, SSB sub-carrier offset, DMRS type, PDCCH configuration, cell access permission information, intra-frequency cell re-selection information, SSB index and/or frame timing information.

Some embodiments may include an indication in a 5G cell access broadcast (e.g., SSB) transmission to request 6G cell access broadcast (e.g., SSB) transmission.

In an embodiment, a WTRU may determine to perform an uplink transmission to request a 6G cell access broadcast (e.g., SSB) transmission when a WTRU may receive a 6G cell access broadcast (e.g., SSB) transmission request indication. The 6G cell access broadcast (e.g., SSB) transmission indication may be (pre)configured as one or more of the following:
An indication using one or more (pre)configured reserved/spare/unused information field(s)/bit(s) in cell access information indicated by higher layer, e.g., a spare bit in a 5G master information block (MIB) transmitted in a 5G PBCH.
An indication using the (pre)configured reserved/spare/unused information field(s)/bit(s) in PBCH payload indicated by lower layer. In one example, a UE may be (pre)configured a number of reserved bit(s) in a SSB index indication in PBCH and a UE may determine the available reserved bits based on the carrier frequency of a received SSB transmission. A UE may determine a 6G cell access information indication using two reserved bits when the carrier frequency of the received SSB transmission may be below 3 GHZ. A UE may determine a 6G cell access information indication using one reserved bit when the carrier frequency of the received SSB transmission may be between 3 GHZ and 6 GHz. A UE may determine a 6G cell access information indication may not be present in the SSB index indication when the carrier frequency of the received SSB transmission may be above 6 GHz.
An indication using (pre)configured reserved/unused codepoint(s) in information field(s) in PBCH, i.e. codepoint(s) not applied for 5G cell access information. In one example, a UE may determine 6G cell access information may be present in the PBCH based on one or more reserved/unused codepoint(s) indicated in the PDCCH CORESET information field. The reserved/unused codepoint(s) may be (pre)configured based on carrier frequency, SCS of the received SSB transmission and/or PDCCH SCS indicated in the PBCH.

Some embodiments may include WTRU determination of 6G cell access broadcast (e.g., SSB) request transmission configuration.

In an embodiment, when a WTRU may be indicated to perform a 6G cell access broadcast (e.g., SSB) request transmission, the WTRU may perform a request transmission based on a configuration regarding any one or more of the following: SCS, waveform (e.g., CP-OFDM, DFT-s-OFDM, Filtered OFDM and/or SC-FDE), transmit sequence, time and frequency resource, TCI state, and/or transmit power.

According to an embodiment, a WTRU may be (pre)configured with a set of 6G cell access broadcast (e.g., SSB) request transmission configurations with each configuration associated with any one or more of the following: PCI of the 5G SSB transmission in which a UE may receive a 6G cell access broadcast (e.g., SSB) transmission request, index (e.g., SSB index) of the received 5G cell access broadcast (e.g., SSB) transmission, PDCCH configuration (e.g., CORESET resource allocation and starting PDCCH symbol of search space).

In an embodiment, the resources (e.g. preambles, waveforms, time and frequency resources) associated with the 6G cell access broadcast (e.g., SSB) request transmission configurations may be received from the same cell in which the WTRU detects the 5G cell access broadcast (e.g., SSB) transmission(s) or from another cell in which the WTRU may camp on and/or receive the 5G/6G cell access broadcast (e.g., SSB) transmission(s).

According to an embodiment, a WTRU may be (pre)configured with a set of 6G cell access broadcast (e.g., SSB) request transmission sequences. Each request transmission sequences may be associated with e.g., PCI and/or index (e.g., SSB index) of the received 5G cell access broadcast (e.g., SSB) transmission in which the 6G cell access broadcast (e.g., SSB) transmission request may be indicated. A WTRU may determine a sequence based the (pre)configured association and the corresponding indication in the received 5G cell access broadcast (e.g., SSB) transmission. In another example, a WTRU may scramble a 6G cell access broadcast (e.g., SSB) request transmission sequence with a PCI derived from the 5G cell access broadcast (e.g., SSB) transmission. A WTRU may determine a PCI based on the 5G PCI derived from the synchronization sequences (e.g., PSS and SSS sequences) of the received 5G cell access broadcast (e.g., SSB) transmission. In one example, the PCI may be identical to 5G PCI. In another example, the PCI may be a function (e.g., sum) of the 5G PCI and a (pre)configured offset. The sequence may thus be associated with a 5G cell access broadcast (e.g., SSB) transmission and not specific to a WTRU.

In an embodiment, a WTRU may determine a timing of the request transmission based on the symbol, slot, sub-frame and/or frame timing the WTRU acquire from the 5G cell access broadcast (e.g., SSB) transmission. In one example, a WTRU may be (pre)configured with a time offset relative to the acquired 5G cell access broadcast (e.g., SSB) timing. The time offset may be a number of symbols, slots, sub-frames and/or frames. In another example, a WTRU may apply the PDCCH CORESET start symbol and/or starting PDCCH symbol of search space indicated in or by the received 5G broadcast channel (e.g., PBCH). In an example, a WTRU may be (pre)configured with a transmission pattern including one or more request transmission occasion relative to the timing of the received 5G cell access broadcast (e.g., SSB) transmission including the 6G cell access broadcast (e.g., SSB) transmission request indication.

According to an embodiment, a WTRU may be (pre)configured with a transmission bandwidth of the request transmission. A WTRU may determine the frequency resource of the request transmission based on the frequency resource allocation of the received 5G cell access broadcast (e.g., SSB) transmission. In one example, a WTRU may determine the start sub-carrier/RB as a function (e.g., sum) of a (pre)configured frequency offset and the start sub-carrier/RB of the received 5G cell access broadcast (e.g., SSB) transmission. In an example, a WTRU may be (pre)configured with GFCN and/or ARFCN of the 6G cell access broadcast (e.g., SSB) request transmission associated with the GFCN and/or ARFCN of a 5G cell access broadcast (e.g., SSB) transmission including the request indication. Thus, a WTRU may determine the frequency resource allocation, e.g., GSCN and/or ARFCN of a 6G cell access broadcast (e.g., SSB) request transmission based on the (pre) configuration and the GSCN and/or ARFCH of the received 5G cell access broadcast (e.g., SSB) transmission. In a further example, a WTRU may be (pre)configured with a fixed frequency allocation for the 6G cell access broadcast (e.g., SSB) request transmission for the carrier frequency used by the received 5G cell access broadcast (e.g., SSB) transmission.

In an embodiment, a WTRU may perform the 6G cell access broadcast (e.g., SSB) request transmission using a transmit spatial filter configuration (e.g., TX beam) corresponding to the receive spatial filter configuration (e.g., RX beam) applied to received 5G cell access broadcast (e.g., SSB) transmission. In another example, a WTRU may perform the 6G cell access broadcast (e.g., SSB) request transmission using a transmit spatial filter configuration (e.g., TX beam) corresponding to the TCI state and/or index (e.g., SSB index) associated with received 5G cell access broadcast (e.g., SSB) transmission.

According to an embodiment, a WTRU may be (pre)configured with a set of request transmission configurations. In one example, a WTRU may be (pre)configured with one or more transmission multiplexing pattern(s) relative to the 5G cell access broadcast (e.g., SSB) transmission. The multiplexing pattern may indicate the time and frequency resources allocated for the 6G cell access broadcast (e.g., SSB) request transmission relative to the time and frequency resources of the received 5G cell access broadcast (e.g., SSB) transmission. A WTRU may determine to apply a request transmission configuration indicated (e.g., using an index) in an information field in a received 5G broadcast channel (e.g., PBCH). In one example, when a WTRU may receive a 5G NCD-SSB based on the sub-carrier offset value, the WTRU may select a request transmission as indicated by one or more (pre)configured reserved value in the PDCCH configuration indication field. In an example, a WTRU may select a request transmission as indicated by one or more (pre)configured codepoint(s) in the reserved bit(s) in the broadcast channel (e.g., PBCH) payload indicated by lower layer.

According to an embodiment, a WTRU may be indicated with a transmit power of the 5G cell access broadcast (e.g., SSB) transmission to be requested. A WTRU may determine a 6G cell access broadcast (e.g., SSB) request transmission power as a function of the indicate 5G cell access broadcast (e.g., SSB) transmission power, the RSRP and/or RSSI of the received 5G cell access broadcast (e.g., SSB) transmission including the 6G cell access broadcast (e.g., SSB) transmission request and a (pre)configured a reference power level. In one example, a WTRU may determine a path loss based on the indicated and received 5G cell access broadcast (e.g., SSB) transmission power level. A WTRU may subsequently determine a 6G cell access broadcast (e.g., SSB) request transmission power based on the sum of the path loss and the (pre)configured reference power level.

In an embodiment, a WTRU may be indicated with one or mor above-discussed 6G cell access broadcast (e.g., SSB) request transmission configurations in 5G higher layer signaling, e.g. in MAC CE and/or RRC signaling.

Upon transmission of the 6G cell access broadcast (e.g., SSB) request based on the received 5G cell access broadcast (e.g., SSB) transmission, a WTRU may monitor and receive a requested 6G cell access broadcast (e.g., SSB) transmission. In an embodiment, a WTRU may perform the monitoring within a frequency range based on the GSCN of the received 5G cell access broadcast (e.g., SSB) transmission. In one example, the frequency range may be indicated by a starting and ending GSCN as a function of the GSCN of the received 5G cell access broadcast (e.g., SSB) transmission and a frequency offset. A WTRU may determine the starting GSCN by subtracting 5G SSB GSCN by the offset and ending GSCN by adding 5G SSB GSCN with the offset. In an example, a WTRU may perform the monitoring within a frequency range indicated in a received 5G broadcast channel (e.g., PBCH). In one example, a WTRU may be indicated with an abovementioned frequency offset using a reserved codepoint(s) in a PDCCH configuration indication field in a 5G broadcast channel (e.g., PBCH).

Some embodiments may include or may be directed to WTRU determination and/or reception of 6G cell access broadcast (e.g., SSB) transmission information based on a received 5G cell access broadcast (e.g., SSB) transmission.

According to an embodiment, a WTRU may detect and/or receive a 5G cell access broadcast (e.g., SSB) transmission at a frequency location denoted by a GSCN. A WTRU may acquire time and frequency synchronization and a 5G PCI based on the received synchronization (e.g., PSS and SSS) sequences. A WTRU may receive a 5G broadcast channel (e.g., may receive information on a PBCH) within the received 5G cell access broadcast (e.g., SSB) transmission.

In an embodiment, a 6G cell access broadcast transmission (e.g., a 6G SSB transmission) may include signal(s) and/or channel(s) according to any one or more of the following configurations. A 6G cell access broadcast channel, e.g., a 6G PBCH carrying cell access information a WTRU may use to acquire cell access, e.g., receive cell system information (SIB1) transmission. 6G SSB transmission including such a PBCH may be referred to as a CD-SSB transmission. A 6G cell access broadcast channel, e.g., 6G PBCH carrying part of the cell access information that may be common among a group of cells. 6G SSB transmission including such a PBCH may be referred to as default/primary SSB transmission. In an embodiment, a default/primary SSB transmission may carry cell access information that a WTRU may use to acquire cell access, e.g., receive cell system information (e.g., SIB1) transmission and may be considered as a CD-SSB. A WTRU may not be able to determine cell access information of a specific 6G cell based on a receive default/primary SSB transmission. A 6G cell access broadcast channel, e.g., 6G PBCH carrying part of the cell access information and/or additional information a WTRU may use to detect and receive a 6G cell access broadcast channel. 6G SSB transmission including such a PBCH may be referred to as supplementary/secondary SSB transmission. A WTRU may determine cell access information of a 6G cell by an aggregation of cell access information received in a supplementary/secondary and a default/primary cell access broadcast (e.g., SSB) transmissions. In another example, a WTRU may detect and/or receive a CD-SSB transmission and determine cell access information of a specific 6G cell based on information indicated in a received supplementary/secondary cell access broadcast (e.g., SSB) transmission. 6G synchronization signal(s) (e.g., 6G PSS and SSS).

According to an embodiment, a WTRU may be (pre)configured with a 6G cell access broadcast (e.g., SSB) transmission configuration when the 6G cell access broadcast (e.g., SSB) transmission information may be indicated in a 5G cell access broadcast (e.g., SSB) transmission. For example, a WTRU may be (pre)configured to detect and/or receive a 6G cell access broadcast (e.g., SSB) transmission including PBCH when a WTRU may receive 6G cell access broadcast (e.g., SSB) transmission information in received 5G cell access broadcast (e.g., SSB) transmission. A WTRU may apply time and frequency synchronization derived from the received 5G cell access broadcast (e.g., SSB) transmission and/or indicated 6G PCI to decode a 6G PBCH in the 6G cell access broadcast (e.g., SSB) transmission. In another example, a WTRU may be (pre)configured to detect and receive a 6G cell access broadcast (e.g., SSB) transmission that may include PSS, SSS and PBCH transmissions when a WTRU may receive 6G cell access broadcast (e.g., SSB) transmission information in received 5G cell access broadcast (e.g., SSB) transmission. A WTRU may acquire time and frequency synchronization and a 6G PCI based on the 6G PSS/SSS transmission when the WTRU may detect and receive the 6G cell access broadcast (e.g., SSB) transmission before decoding the PBCH.

In a further example, a WTRU may be (pre)configured to detect and/or receive a supplementary/secondary cell access broadcast (e.g., SSB) transmission when a WTRU may detect and receive 5G PSS and/or SSS transmission. A WTRU may apply time and frequency synchronization derived from the received 5G cell access broadcast (e.g., SSB) transmission and/or indicated 6G PCI to decode a 6G PBCH in the 6G cell access broadcast (e.g., SSB) transmission. Also, a WTRU may perform a blind decoding of DMRS using a set of (pre)configured DMRS sequences. A WTRU may determine whether a supplementary/secondary, default/primary or CD-SSB transmission may be received when the corresponding (pre)configured DMRS sequence may be decoded.

In an embodiment, a UE may be (pre)configured to detect and/or receive a supplementary/secondary cell access broadcast (e.g., SSB) transmission when a WTRU may be in IDLE and/or INACTIVE state. A WTRU may be (pre)configured to detect and/or receive a supplementary/secondary and/or a default/primary cell access broadcast (e.g., SSB) transmission when a WTRU may be in CONNECTED state. When a WTRU may determine which cell access broadcast (e.g., SSB) transmission to detect and/or receive, a WTRU may detect and/or receive the cell access broadcast (e.g., SSB) transmission according to any one or more of the following: within pre-configured frequency resources, e.g., GSCN and/or ARFCN associated with the determined SSB transmission, using a pre-configured PBCH DMRS sequence corresponding to the determined SSB transmission, and/or using a pre-configured PCI in scrambling configuration of PBCH DMRS sequences and/or PBCH payload bits.

In another solution, a UE may be indicated with a 6G SSB transmission configuration in the 6G SSB transmission information included in a 5G SSB transmission. The indication may base on e.g., a PBCH DMRS sequence index and a UE may be (pre)configured with different DMRS sequence for a 6G supplementary/secondary SSB transmission, default/primary SSB transmission and/or 6G SSB transmission. Alternatively, a one-bit information filed e.g., using one reserved bit in the PBCH, may be (pre)configured to indicate the 6G SSB transmission configuration.

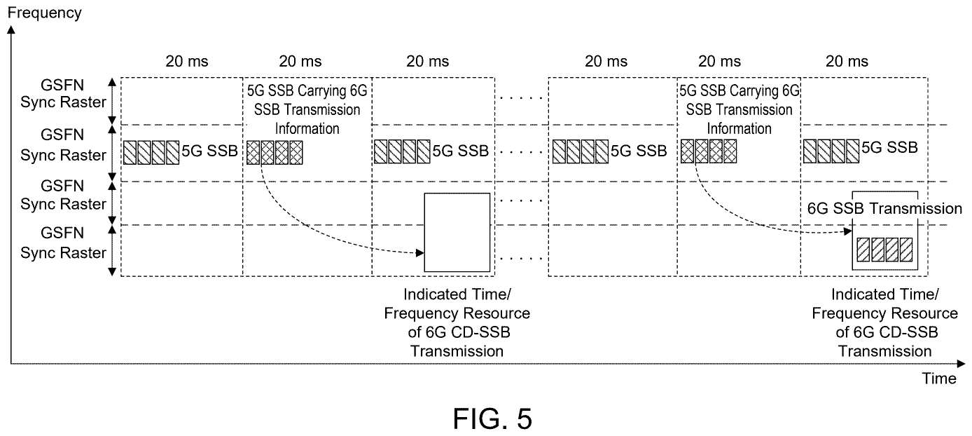

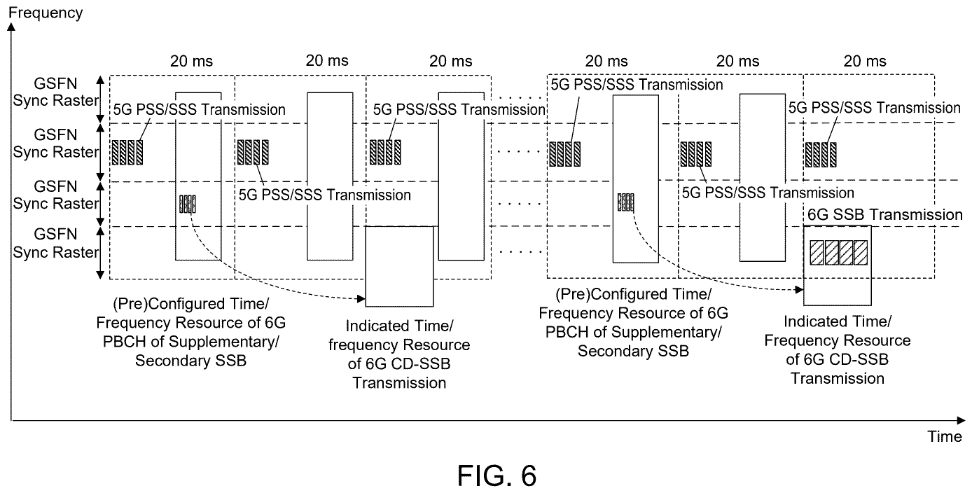

The introduction the 6G cell access broadcast (e.g., SSB) transmission configuration that may be associated with 5G PSS/SSS transmission and/or 5G cell access broadcast (e.g., SSB) transmission (including PSS/SSS/PBCH) may provide network energy saving benefit by allowing sparse transmission of 6G cell access broadcast (e.g., SSB), for example, as shown in the examples of FIGS. 3 and 5. Also, with a 6G broadcast indication channel transmission, the 6G PBCH transmissions carrying full payload of cell access information may be further reduced, as shown in the example of FIG. 6.

Some embodiments may include or may be directed to WTRU determination of the presence of 6G cell access broadcast (e.g., SSB) transmission information in a received 5G cell access broadcast (e.g., SSB) transmission.

In an embodiment, a WTRU may determine 6G cell access broadcast (e.g., SSB) transmission information may be present in a received 5G PBCH based on one or more 6G cell access broadcast (e.g., SSB) transmission information indication field(s) in the received 5G PBCH. A WTRU may detect and receive one or more 6G cell access broadcast (e.g., SSB) transmissions based on the 6G cell access broadcast (e.g., SSB) transmission information present in a received 5G cell access broadcast (e.g., SSB) transmission. In this case, a WTRU may determine the received 5G cell access broadcast (e.g., SSB) transmission may be associated with one or more 6G cell access broadcast (e.g., SSB) transmission(s).

Some embodiments may provide for content of 6G cell access broadcast (e.g., SSB) transmission information in a received 5G cell access broadcast (e.g., SSB) transmission. In an embodiment, the 6G cell access broadcast (e.g., SSB) transmission information may include any one or more of the following parameters, properties, and/or characteristics of associated 6G SSB transmission(s): Time domain resource allocation, Frequency domain resource allocation, Waveform, 6G PCI, and/or Transmit power.

In an embodiment, the time domain resource allocation information may be indicated by a (pre)configured multiplexing pattern between 5G and 6G SSB transmissions. A WTRU may be (pre)configured with a set of indexed multiplexing pattens. Each pattern may be associated with a frequency range (e.g., FR1, FR2, etc.) and/or a SCS (e.g., 15 kHz, 30 kHz, 60 kHz, 120 kHz, 240 kHz, 480 kHz, etc.). A transmission multiplexing pattern may indicate the symbol(s), slot, sub-frame, frame of associated 6G SSB transmission(s) relative to a received 5G SSB transmission. The pattern may also include a periodicity of the associated 6G SSB transmission corresponding to one of (pre)configured periodicities (e.g., 20 ms, 40 ms, 80 ms, 160 ms, 320 ms, etc.). A WTRU may determine time domain resource allocation of associated 6G SSB transmission(s) as indicated by an index corresponding to a (pre)configured 6G SSB transmission multiplexing pattern.

In an embodiment, a WTRU may determine time domain resource allocation of associated 6G SSB transmission(s) based on one or more timing(s) offset indicated in the received 5G SSB transmission. The timing offset may be relative to the received 5G SSB transmission and indicated with an integer number of symbol(s), slot(s), sub-frame(s) and/or frame(s). A WTRU may be indicated with a periodicity of the associated 6G SSB transmission(s) in the received 5G PBCH. The indication may be an index corresponding to one of the (pre)configured periodicities (e.g., 20 ms, 40 ms, 80 ms, 160 ms, 320 ms, etc.).

In an embodiment, a WTRU may determine the associated 6G cell access broadcast (e.g., SSB) transmission(s) may be transmitted at a GSCN and/or ARCFN identical to the GSCN and/or ARFCN of the received 5G cell access broadcast (e.g., SSB) transmission. In an embodiment, a WTRU may determine a GSCN and/or ARCFN of the associated 6G cell access broadcast (e.g., SSB) transmission(s) as a function (e.g. sum) of the GSCN and/or ARCFN of the received 5G cell access broadcast (e.g., SSB) transmission and a frequency resource offset indicated in the received 5G PBCH. In a further example, a WTRU may determine a range of GSCN and/or ARCFN of the associated 6G cell access broadcast (e.g., SSB) transmission(s). For example, the starting and ending GSCN and/or ARCFN of the range may be a function (e.g., sum) of the GSCN and/or ARCFN of the received 5G cell access broadcast (e.g., SSB) transmission and a frequency resource offset indicated in the received 5G PBCH. The frequency resource offset may be indicated as an integer number of sub-carriers, RBs and/or synchronization rasters. A synchronization raster may be (pre)configured as an integer number of sub-carriers and/or RBs between GSCN in a carrier. A WTRU may detect and receive at each GSCN and/or ARCFN within the indicated range. In an embodiment, a WTRU may be indicated by an index corresponding to a (pre)configured 5G and 6G cell access broadcast (e.g., SSB) transmission multiplexing pattern in frequency domain. A WTRU may be (pre)configured with a set of indexed frequency domain multiplexing patterns. A pattern (e.g., each pattern) may be associated with a frequency range (e.g., FR1, FR2, etc.) and/or a SCS (e.g., 15 kHz, 30 kHz, 60 kHz, 120 kHz, 240 kHz, 480 kHz, etc.). A frequency domain multiplexing pattern may indicate the GSCN and/or ARFCN of associated 6G cell access broadcast (e.g., SSB) transmission(s) relative to a received 5G SSB transmission. A WTRU may determine the GSCN and/or ARFCN of the associated 6G cell access broadcast (e.g., SSB) transmission(s) as indicated e.g., by an index corresponding to a (pre)configured frequency domain multiplexing pattern.

In an embodiment, a WTRU may determine the waveform of the associated 6G cell access broadcast (e.g., SSB) transmission(s) based on the indication received in a 5G cell access broadcast (e.g., SSB) broadcast channel (e.g., PBCH). The synchronization signal and/or broadcast channel transmissions included in a 6G cell access broadcast (e.g., SSB) transmission may be (pre)configured to apply one or more of the waveforms including CP-OFDM, DFT-s-OFDM, Filtered-OFDM, Single-Carrier Frequency Domain Equalization (SC-FDE), etc. In one example, a WTRU may be (pre)configured with different receiving configuration for 6G SSB transmission based on CP-OFDM and DFT-s-OFDM waveforms. A WTRU may determine to apply the receiving configuration corresponding to the waveform indicated in the received 5G PBCH when the WTRU may detect and/or receive the associated 6G SSB transmission. In some embodiments, the indication may be, for example, a one-bit information field in the 5G PBCH. A WTRU may apply a M-point DFT (Discreet Fourier Transform) in the receiving configuration to detect and receive a 6G cell access broadcast (e.g., SSB) transmission using DFT-s-OFDM waveform. In one example, a WTRU may determine the value of M based on a (pre)configured number of sub-carriers and/or RBs used for 6G synchronization signal and/or broadcast channel transmission. In another example, a WTRU may determine the value of M based on the number of sub-carriers and/or RBs used for the received 5G cell access broadcast (e.g., SSB) transmission.

In an embodiment, a WTRU may determine a 6G PCI identical with the 5G PCI of the received 5G cell access broadcast (e.g., SSB) transmission. In an embodiment, a WTRU may be indicated in a received 5G PBCH with a PCI offset. The indication field may be based on the reserved bit(s) in PBCH payload indicated by lower layer. A codepoint (e.g., each codepoint) of the indication field (e.g., two codepoints using one reserve bit and four codepoints using two reserved bits) may be (pre)configured to indicate a PCI offset. A WTRU may determine a 6G PCI as a function (e.g., sum) of the 5G PCI indicated in the received cell access broadcast (e.g., SSB) transmission and the indicated offset. In an embodiment, a WTRU may determine a 6G PCI as a function (e.g., a sum) of a 5G PCI determined based on the received 5G cell access broadcast (e.g., SSB) transmission and a (pre)configured PCI offset.

In an embodiment, a WTRU may be indicated with a transmit power and/or power class of an associated 6G cell access broadcast (e.g., SSB) transmission. A WTRU may be (pre)configured with a range of power class, e.g., high power class and/or low power class. The power class may depend on the 6G base station (e.g., gNB) transmission power. In an embodiment, a WTRU may be indicated with transmit power offset between the associated 6G cell access broadcast (e.g., SSB) transmission and received 5G cell access broadcast (e.g., SSB) transmission.

Some embodiments may include indications for 6G cell access broadcast (e.g., SSB) transmission(s) in a received 5G cell access broadcast (e.g., SSB) transmission.

In an embodiment, a WTRU may be (pre)configured with a 6G cell access broadcast (e.g., SSB) transmission information indication in a 5G PBCH. The 6G cell access broadcast (e.g., SSB) transmission information indication may be (pre)configured as any one or more of the following:
An indication using one or more (pre)configured reserved/spare/unused information field(s)/bit(s) in cell access information indicated by higher layer, e.g., a spare bit in a 5G master information block (MIB) transmitted in a 5G PBCH.
An indication using the (pre)configured reserved/spare/unused information field(s)/bit(s) in PBCH payload indicated by lower layer. In one example, a WTRU may be (pre)configured a number of reserved bit(s) in a SSB index indication in PBCH and a WTRU may determine the available reserved bits based on the carrier frequency of a received 5G SSB transmission. A WTRU may determine a 6G SSB transmission information indication using two reserved bits when the carrier frequency of the received SSB transmission may be below 3 GHZ. A WTRU may determine a 6G SSB transmission information indication using one reserved bit when the carrier frequency of the received SSB transmission may be between 3 GHZ and 6 GHz. A WTRU may determine a 6G SSB transmission information indication may not be present in the SSB index indication when the carrier frequency of the received SSB transmission may be above 6 GHZ.
An indication using (pre)configured reserved/unused codepoint(s) in information field(s) in PBCH, i.e. codepoint(s) not applied for 5G cell access information. In one example, a WTRU may determine 6G SSB transmission may be indicated using one or more reserved/unused codepoint(s) in the PDCCH CORESET information field. The reserved/unused codepoint(s) may be (pre)configured based on carrier frequency, SCS of the received SSB transmission and/or PDCCH SCS indicated in the PBCH.

According to an embodiment, a 5G WTRU may not attempt to decode (pre)configured reserved, spare, and/or unused information field(s) and/or bit(s) in MIB and/or lower layer-generated payload in a received 5G PBCH. A 5G WTRU may not expect to receive a (pre)configured reserved/unused codepoint(s) in decoded information fields/bit(s) in a received 5G PBCH.

In an embodiment, a WTRU may determine based on the abovementioned indications that 6G cell access broadcast (e.g., SSB) transmission information may not be indicated in a received 5G cell access broadcast (e.g., SSB) transmission. In this case, a WTRU may discard the received 5G cell access broadcast (e.g., SSB) transmission and attempt to detect and receive another 5G and/or 6G cell access broadcast (e.g., SSB) transmission.

In an embodiment, when a WTRU may determine 6G cell access broadcast (e.g., SSB) transmission information may be indicated in a received 5G cell access broadcast (e.g., SSB) transmission, a WTRU may further determine whether or not to detect and receive the associated 6G cell access broadcast (e.g., SSB) transmission(s), for example, based on the RSRP and/or RSSI level of the received 5G PSS/SSS and/or PBCH transmission. In one example, a WTRU may attempt to detect and/or receive the associated 6G cell access broadcast (e.g., SSB) transmission(s) based on the received 6G cell access broadcast (e.g., SSB) transmission information when the RSRP and/or RSSI level of the received 5G PSS/SSS and/or PBCH transmission may be above a (pre)configured threshold. Otherwise, a WTRU may detect and/or receive another 5G and/or 6G cell access broadcast (e.g., SSB) transmission.

In some embodiments, a WTRU may detect and/or receive associated 6G cell access broadcast (e.g., SSB) transmissions, for example, based on 6G cell access broadcast (e.g., SSB) transmission information indicated in a received 5G cell access broadcast (e.g., SSB) transmission. FIG. 5 illustrates an example of WTRU reception of 6G cell access broadcast (e.g., SSB) transmission based on the information indicated or included in a 5G cell access broadcast (e.g., SSB) transmission, according to certain embodiments.

According to an embodiment, a WTRU may determine that 6G cell access broadcast (e.g., SSB) transmission information may be indicated in a received 5G PBCH and detect and/or receive the associated 6G cell access broadcast (e.g., SSB) transmission based on the indicated information in accordance with any one or more of the following examples.

In one example, a WTRU may determine a 5G NCD-SSB may be received as discussed above with respect to WTRU determination of cell access information of a 5G cell in a 5G SSB transmission based on indication(s) received in the PBCH and the PDCCH configuration information field may not be used for 5G PDCCH configuration information indication.

In another example, a WTRU may determine 6G cell access broadcast (e.g., SSB) transmission information may be present in the received 5G PBCH based on indication of a (pre)configured codepoint at the spared bit in the received 5G MIB. For example, codepoint 1 may be (pre)configured to indicate the presence and 0 to indicate otherwise.

In another example, a WTRU may determine a 6G cell access broadcast (e.g., SSB) transmission waveform based on an indication of a (pre)configured codepoint at a reserved bit in the PBCH payload indicated by lower layer. For example, the codepoint of 1 and 0 may be (pre)configured to indicate DFT-s-OFDM and CP-OFDM, respectively. In another example, a WTRU may be (pre)configured with applying the same CP-OFDM waveform as used by the 5G cell access broadcast (e.g., SSB) transmission. A WTRU may determine 6G cell access broadcast (e.g., SSB) transmission multiplexing pattern based on an indication of a (pre)configured codepoints at two reserved bits in the PBCH payload indicated by lower layer. For example, the codepoint of 0, 1, 2, and 3 may be (pre)configured to indicate different multiplexing pattern in time domain.

In another example, a WTRU may determine a 6G cell access broadcast (e.g., SSB) transmission frequency resource based on the indication of a (pre)configured codepoint at the PDCCH configuration information field in the PBCH. In one example, one or more codepoints using the 8-bit information PDCCH configuration information field may be (pre)configured to indicate a frequency resource offset and/or a frequency resource range.

In another example, a WTRU may apply a (pre)configured receiving configuration corresponding to the waveform indicated in the 6G cell access broadcast (e.g., SSB) transmission information and detect and receive 6G cell access broadcast (e.g., SSB) transmission at a frequency resource and/or within a frequency range indicated in the 6G SSB transmission information. In one example, a WTRU may apply a M-point DFT (Discreet Fourier Transform) in the receiving configuration to detect and receive a 6G cell access broadcast (e.g., SSB) transmission using DFT-s-OFDM waveform. A WTRU may determine the value of M based on a (pre)configured number of sub-carriers and/or RBs used for 6G synchronization signal and/or broadcast channel transmission. In another example, a WTRU may determine the value of M based on the number of sub-carriers and/or RBs used for the received 5G PSS and SSS transmission.

In another example, a WTRU may determine the associated 6G cell access broadcast (e.g., SSB) transmission and the receive 5G cell access broadcast (e.g., SSB) transmission may be QCL: ed and a WTRU may apply a receive spatial filter configuration (e.g., RX beam) based on the configuration used for receiving the 5G cell access broadcast (e.g., SSB) transmission.

According to some embodiments, a WTRU may detect and/or receive a 6G cell access broadcast (e.g., SSB) transmission based on 6G cell access broadcast (e.g., SSB) transmission information indicated or included in 5G higher layer signaling.

In an embodiment, a WTRU may be (pre)configured with 6G cell access broadcast (e.g., SSB) transmission information in 5G higher layer configuration signaling, e.g., MAC and RRC signaling. A WTRU may be indicated with one or more following parameters, properties, and/or characteristics of 6G cell access broadcast (e.g., SSB) transmission to detect and receive: 6G PCI, transmission bandwidth (e.g. number of sub-carrier, RBs used by the 6G SSB transmission), Waveform (e.g., CP-OFDM, DFT-s-OFDM, Filtered-OFCM, SC-FDE, etc. A WTRU may apply a (pre)configured receiver configuration corresponding to the indicated waveform to receive and detect the indicated 6G cell access broadcast (e.g., SSB) transmission. In one example, a WTRU may apply a M-point DFT to detect and receive 6G PSS, SSS and/or PBCH with M determined based on the indicated bandwidth), Time resource allocation (e.g., starting symbol, slot, sub-frame, SFN, periodicity of the SSB transmission, etc. In another example, a time domain multiplexing pattern relative to one or more 5G SSB transmissions(s) may be included. A WTRU may be (pre)configured with the 5G SSB transmission(s) for measurement, radio link monitoring (RLM), beam failure recovery (BFR), time and frequency synchronization, etc.), Frequency resource allocation (e.g., GSCN, ARFCN, carrier frequency, RB index, etc. In another example, a WTRU may be indicated with a frequency range with starting and ending RB, GSCN and/or ARFCN. In a further example, a frequency domain multiplexing pattern relative to one or more indicated 5G SSB transmissions(s) may be included. A WTRU may be (pre)configured with the indicated 5G SSB transmission(s) for measurement, radio link monitoring (RLM), beam failure recovery (BFR), time and frequency synchronization, etc.), PBCH DMRS sequence index, SSB index (e.g., a SSB index indicting a 5G SSB transmission that a WTRU may be (pre)configured with for measurement, radio link monitoring (RLM), beam failure recovery (BFR), time and frequency synchronization, etc.), TCI state (e.g., a WTRU may determine the indicated 6G cell access broadcast (e.g., SSB) transmission(s) may be QCL: ed with the downlink reference signal indicated in the TCI state. A WTRU may thus detect and receive the indicated 6G SSB transmission using a receive spatial filter configuration corresponding to the indicated TCI state), (pre)configured indication of resource(s) (e.g., in one example, a WTRU may be (pre)configured with an indication of resource allocated for a SSB transmission, e.g., an index that may denote (pre)configured time and/or frequency resources, i.e., SSB resource indication (SRI). An SRI may indicate necessary information to detect a SSB transmission).

According to an embodiment, a WTRU may detect and receive a 6G cell access broadcast (e.g., SSB) transmission within the indicated time and frequency resources. A WTRU may further determine the indicated 6G cell access broadcast (e.g., SSB) transmission may be received when one or more indicated parameters/properties/characteristics of the received 6G cell access broadcast (e.g., SSB) transmission may be identical with the corresponding parameters, properties, and/or characteristics indicated in 5G higher layer signaling. In one example, a WTRU may determine an indicated 6G cell access broadcast (e.g., SSB) transmission may be received when the 6G cell access broadcast (e.g., SSB) transmission may be received at indicated time and frequency resource allocation and the 6G PCI determined e.g., based on 6G PSS/SSS transmissions may be identical with (or similar to) the indicated PCI.

According to some embodiments, a WTRU may detect and/or receive 6G broadcast transmission(s) associated with received 5G synchronization signal (e.g., PSS/SSS) transmission. FIG. 6 illustrates an example of WTRU reception of a 6G broadcast indication channel associated with 5G PSS and SSS transmission, according to certain embodiments.

In an embodiment, a WTRU may be (pre)configured with a time and frequency multiplexing pattern between 5G PSS/SSS transmission and an associated 6G SSB transmission. A WTRU may determine the 6G SSB transmission configuration regarding the included signal(s) and channel(s) as discussed above.

According to some embodiments, a WTRU may detect and/or receive a 6G SSB transmission in accordance with any one or more of the following examples.

In one example, a WTRU may determine to apply SCS and waveform identical to those of the received 5G PSS/SSS transmission. In another solution, a WTRU may determine the SCS and/or waveform used for the supplementary/secondary SSB transmission based on (pre) configuration. In one example, a WTRU may be (pre)configured with DFT-s-OFDM waveform and use M-point DFT in the receiving configuration for the 6G SSB transmission. A WTRU may determine the value of M based on a (pre)configured number of sub-carriers and/or RBs used for 6G synchronization signal and/or broadcast channel transmission.

In one example, a WTRU may be (pre)configured with one or more time resource allocation(s) in which the WTRU may detect and receive a 6G SSB transmission. In one example, the time domain resource allocation may be indicated by a (pre)configured set of time offsets relative to the received 5G PSS and SSS transmissions. A (pre)configured time offset may be an integer number of symbol(s), slot(s), sub-frame(s) and/or frames. A WTRU may attempt to detect and receive a 6G SSB transmission within one or more (pre)configured time domain resource(s).

In one example, a WTRU may be (pre)configured with an association between the frequency resource, e.g., GSCN and/or ARFCN of a 5G PSS and SSS transmission and associate 6G SSB transmission(s). In one example, the associated 6G SSB(s) may be transmitted at a GSCN and/or ARCFN identical to the GSCN and/or ARFCN of the received 5G PSS and SSS transmission. In another example, a WTRU may determine a GSCN and/or ARCFN of the associated 6G SSB transmission(s) as a function of the GSCN and/or ARCFN of the received 5G PSS and SSS transmission and a (pre)configured frequency resource offset. The (pre)configured frequency resource offset may be an integer number of sub-carriers, RBs, and/or sync rasters. A WTRU may determine one or more (pre)configured frequency offset(s) to apply based on the carrier frequency range (e.g., FR1, FR2, etc.) and/or a SCS (e.g., 15 kHz, 30 kHz, 60 kHz, 120 kHz, 240 kHz, 480 kHz, etc.) of the received 5G PSS and SSS transmissions. A WTRU may determine the frequency resource of the associated 6G SSB transmission(s), e.g., GSCN and/or AFRCN may be located within a frequency resource range between (the frequency resource of 5G SSB transmission−frequency offset) and (the frequency resource of 5G SSB transmission+frequency offset).

In one example, a WTRU may be (pre) configure with a time and/or frequency multiplexing pattern between 5G PSS and SSS transmission and associated 6G SSB transmission. A WTRU may thus determine the time and/or frequency resource allocation(s) based on the (pre)configured multiplexing pattern and the time and/or frequency resources of the received 5G PSS and SSS transmissions. The pattern may also indicate a periodicity of the associated 6G SSB transmission corresponding to one of (pre)configured periodicities (e.g., 20 ms, 40 ms, 80 ms, 160 ms, 320 ms, etc.). A WTRU may determine a (pre)configured pattern to apply based on the carrier frequency range (e.g., FR1, FR2, etc.) and/or a SCS (e.g., 15 kHz, 30 kHz, 60 kHz, 120 kHz, 240 kHz, 480 kHz, etc.) of the received 5G PSS and SSS transmissions.

In one example, a WTRU may thus detect and receive a 6G SSB transmission at and/or within the frequency resource based on the frequency resource of the 5G PSS and SSS transmission and (pre) configuration.

In one example, a WTRU may determine a 6G PCI identical with the 5G PCI derived from the received 5G PSS and SSS transmission. In another solution, a WTRU may be (pre)configured with a PCI offset. A WTRU may determine a 6G PCI as a function (e.g., sum) of the 5G PCI and the (pre)configured offset. A WTRU may apply the 6G PCI in the descrambling of a received 6G DMRS signal.

In one example, a WTRU may determine the associated 6G SSB transmission and the receive 5G PSS and SSS transmissions may be QCL: ed and a WTRU may apply a receive spatial filter configuration (e.g., RX beam) based on the configuration used for receiving the 5G SSB transmission.

According to certain embodiments, when a WTRU may detect and/or receive a 6G cell access broadcast (e.g., SSB) transmission including a cell broadcast indication transmission, a WTRU may further receive a 6G cell access broadcast (e.g., SSB) transmission carrying 6G cell access broadcast information, as discussed below.

Some embodiments may include or may be directed to WTRU 6G cell access based on cell broadcast indication transmission.

Certain embodiments may include WTRU detection and/or reception of synchronization signal transmission. In an embodiment, a WTRU may detect and receive one or more (pre)configured 6G SSB transmission(s) as discussed above with respect to 6G cell access broadcast (e.g., SSB) transmission according to (pre)configured parameters, properties, and/or characteristics. In an embodiment, a WTRU may be (pre)configured with one or more of the following parameters, properties, and/or characteristics for 6G synchronization signa(s), broadcast indication channel and/or broadcast channel.

For example, a parameter may include transmit sequence of the synchronization signal and/or DMRS of the 6G SSB transmission. A WTRU may be indicated with a cell identity (e.g., PCI) by the sequence(s) transmitted for synchronization signal(s). In one example, a WTRU may determine one or more DMRS sequences of PBCH based on one or more of the following: cell identity indicated by the synchronization signal(s), (pre)configured SSB identifier (e.g., a set of SSB indexes), and/or indication of whether the 6G SSB transmission may include a PBCH. In one example, one or more synchronization signal sequence(s) may be (pre)configured to indicate a supplementary/secondary SSB transmission may be associated with the synchronization signal transmission in the received 6G SSB transmission. Thus, a WTRU may determine a supplementary/secondary SSB transmission may be received based on the detected and received synchronization signal(s). In another example, one or more PCIs indicated by the synchronization signal sequences may be (pre)configured to indicate a supplementary/secondary SSB transmission may be associated with the synchronization signal transmission. In this example, a WTRU may determine whether supplementary/secondary SSB transmission, a default/primary SSB transmission or a CD-SSB transmission may be received based on which group of the (pre)configured synchronization signal sequence(s) may be received.

Another parameter may include transmission bandwidth, e.g. number of sub-carriers, RBs used by the 6G SSB transmission.

Another parameter may include waveform, e.g., CP-OFDM, DFT-s-OFDM, Filtered-OFCM, SC-FDE, etc. A WTRU may apply a receiver configuration corresponding to the (pre)configured waveform. In one example, a WTRU may apply a M-point DFT where M may be based on the (pre)configured bandwidth of the 6G SSB transmission.

Another parameter may include time and frequency domain resource. A WTRU may be (pre)configured with time and frequency resources of a PBCH associated with synchronization signal(s) in a 6G SSB transmission. In one example, a time and frequency domain multiplex pattern may be (pre)configured. Within a (pre)configured pattern, a WTRU may be indicated with the symbol(s), slot(s), sub-frame(s) and/or frame(s) in the time domain and with sub-carrier(s) and/or RB(s) in the frequency domain relative to a synchronization signal transmission

In an embodiment, a WTRU may detect and/or receive (pre)configured synchronization signal(s) and determine a cell identity (e.g., PCI) based on the received synchronization signal sequence(s). In another example, a WTRU may determine the received synchronization signal(s) may be associated with a supplementary/secondary cell access broadcast (e.g., SSB) transmission based on the received synchronization signal sequence(s). A WTRU may determine a set of (pre)configured DMRS sequences based on the cell identity, SSB indexes, indication for supplementary/secondary cell access broadcast (e.g., SSB) transmission, default/primary cell access broadcast (e.g., SSB) transmission or CD-SSB transmission, etc. A WTRU may determine the SSB indexes to use based on the carrier frequency of the received synchronization signal transmission. For example, for carrier frequency in FR1, a WTRU may apply four SSB indexes and each SSB index may corresponding to a different DMRS sequence. In another example, a WTRU may be (pre)configured with different sets of DMRS sequences corresponding to supplementary/secondary cell access broadcast (e.g., SSB) transmission, default/primary cell access broadcast (e.g., SSB) transmission and CD-SSB transmission, respectively.

According to an embodiment, a WTRU may perform a blind detection using the set of DMRS sequences to detect and receive a DMRS transmission within the time and frequency resource associated with the resources of the received synchronization signal, e.g., according to a (pre)configured multiplexing pattern. A WTRU may apply a receive configuration, e.g., a receive spatial filter configuration identical to that used to receive the synchronization signal transmission.

Some embodiments may include WTRU detection and/or reception of CD-SSB based on a received supplementary/secondary cell access broadcast (e.g., SSB) transmission.

According to an embodiment, a WTRU may determine a supplementary/secondary cell access broadcast (e.g., SSB) transmission may be received when the received PBCH DMRS sequence may correspond to the (pre)configured DMRS sequence for supplementary/secondary cell access broadcast (e.g., SSB) transmission. A WTRU may receive supplementary/secondary cell access broadcast (e.g., SSB) transmission using the channel information estimated from the PBCH DMRS transmission. A WTRU may also determine a SSB index corresponding to the received PBCH DMRS sequence of the supplementary/secondary cell access broadcast (e.g., SSB) transmission.

In an embodiment, a WTRU may receive one or more of the following information indicated in the received supplementary/secondary cell access broadcast (e.g., SSB) transmission regarding one or more associated 6G CD-SSB transmission(s) including cell broadcast information, e.g. carried in PBCH: SCS, waveform, time and frequency resource allocation, 6G CD-SSB periodicity, 6G PCI, transmit power, and/or request indication.

In an embodiment, a WTRU may determine the SCS of the associated 6G SSB transmission(s) based on the received indication.

In an embodiment, a WTRU may determine the waveform of the associated 6G SSB transmission(s) based on the received indication received. A WTRU may be indicated with one of the (pre)configured waveforms including e.g., CP-OFDM, DFT-s-OFDM, Filtered-OFDM and/or Single-Carrier Frequency Domain Equalization (SC-FDE). In one solution, a WTRU may be indicated in a one-bit information field with codepoints corresponding to CP-OFDM and DFT-s-OFDM. A WTRU may determine a receiving configuration for 6G SSB transmission based on the indicated waveform. A WTRU may apply additional M-point DFT to receive 6G SSB transmission(s) when DFT-s-OFDM waveform may be indicated.

Time and frequency resource allocation, for example, may include, e.g., starting symbol, slot, sub-frame, SFN, and/or periodicity in time domain and GSCN, ARFCN, carrier frequency and/or RB index in frequency domain of the 6G CD-SSB transmission. In one example, a WTRU may be (pre)configured with one or more time and frequency domain multiplexing pattern(s) between a 6G SSB transmission include supplementary/secondary SSB transmission and CD-SSB transmission. A WTRU may be indicated with an index corresponding to one of the (pre)configured multiplexing pattern. A WTRU may determine the time and frequency resource allocation of the associated 6G CD-SSB transmission relative to the received supplementary/secondary SSB transmission based on this multiplexing pattern. In another example, a WTRU may be indicated with a frequency range with starting and ending RB, GSCN and/or ARFCN.

In an embodiment, a WTRU may be indicated with a periodicity of the associated 6G CD-SSB transmission(s) in a received supplementary/secondary SSB transmission. The indication may be an index corresponding to one of the (pre)configured periodicities (e.g., 20 ms, 40 ms, 80 ms, 160 ms, 320 ms, etc.).

According to an embodiment, a WTRU may be indicated with a PCI of the 6G CD-SSB transmission. In one example, a WTRU may determine a supplementary/secondary SSB transmission may be received as indicated by the received synchronization signal sequence. A WTRU may receive the cell identity, e.g., PCI in the PBCH payload.

In an embodiment, a WTRU may be indicated with a transmit power and/or power class of the received and/or associated 6G SSB transmission. A WTRU may be (pre)configured with a range of power class, e.g., high power class and/or low power class. The power class may depend on the 6G gNB transmission power. In another embodiment, a WTRU may be indicated with transmit power offset between the associated 6G SSB transmission and received 5G SSB transmission.

According to an embodiment, a WTRU may be indicated to perform an uplink transmission to request a 6G CD-SSB transmission.

In an embodiment, a WTRU may receive multiple supplementary/secondary cell access broadcast (e.g., SSB) transmissions, e.g., indicating different SSB indexes. A WTRU may determine which supplementary/secondary cell access broadcast (e.g., SSB) transmission may be applied for detection and reception of the associated 6G CD-SSB transmission and/or for performing an indicated request transmission based on one or more of the following: the RSRP and/or RSSI level measured on the received synchronization signal and/or PBCH transmissions of the supplementary/secondary SSB transmission (e.g., in one example, a WTRU may determine to apply supplementary/secondary SSB transmission with highest measured RSRP and/or RSSI level. In another example, a WTRU may determine to apply the first supplementary/secondary SSB transmission with a measured RSRP and/or RSSI level exceeding a (pre)configured threshold), and/or the indicated transmit power information of the associated 6G CD-SSB transmission (e.g., in one example, a WTRU may determine a path loss based on the indicated power level and the measured RSRP and/or RSSI of the received supplementary/secondary SSB transmission. A WTRU may determine to apply the supplementary/secondary SSB transmission with the lowest path loss).

According to an embodiment, a WTRU may determine the DMRS sequence of the 6G CD-SSB transmission based on the PCI and SSB index indicated in the supplementary/secondary cell access broadcast (e.g., SSB) transmission. A WTRU may detect and receive a 6G CD-SSB transmission associated with the applied supplementary/secondary SSB transmission.

Some embodiments may include WTRU performing 6G CD-SSB request transmission. In an embodiment, when a WTRU may be indicated to perform a 6G CD-SSB request transmission in a supplementary/secondary cell access broadcast (e.g., SSB) transmission, the WTRU may perform a request transmission based on a configuration regarding any one or more of the following: SCS, waveform (e.g., CP-OFDM, DFT-s-OFDM, Filtered OFDM and/or SC-FDE), transmit sequence, time and frequency resource, TCI state, and/or transmit power.

In one embodiment, a WTRU may be (pre)configured with a set of request transmission configurations with the configuration(s) (e.g., each configuration) associated with SSB index indicated in the supplementary/secondary cell access broadcast (e.g., SSB) transmission.

According to an embodiment, a WTRU may be (pre)configured with a set of 6G CD-SSB request transmission sequences. A sequence (e.g., each request transmission sequence) may be associated with, e.g., PCI, and/or SSB index of the received 6G supplementary/secondary cell access broadcast (e.g., SSB) transmission. A WTRU may determine a sequence based the (pre)configured association and the corresponding PCI and/or SSB index indicated in the received supplementary/secondary cell access broadcast (e.g., SSB) transmission.

In an embodiment, a WTRU may determine a timing of the request transmission based on the symbol, slot, sub-frame and/or frame timing the WTRU acquire from the supplementary/secondary cell access broadcast (e.g., SSB) transmission. In one example, a WTRU may be (pre)configured with a time offset relative to the acquired 6G supplementary/secondary cell access broadcast (e.g., SSB) transmission timing. The time offset may be a number of symbols, slots, sub-frames and/or frames. In another example, a WTRU may be indicated with a (pre)configured transmission pattern of 6G CD-SSB transmission(s) relative to the time resource of the received supplementary/secondary cell access broadcast (e.g., SSB) transmission.

According to an embodiment, WTRU may be (pre)configured with a transmission bandwidth of the request transmission. A WTRU may determine the frequency resource of the request transmission based on the frequency resource allocation of supplementary/secondary cell access broadcast (e.g., SSB) transmission and indication received in the supplementary/secondary cell access broadcast (e.g., SSB) transmission. In one solution, a WTRU may determine the start sub-carrier/RB as a function (e.g., sum) of an indicated frequency offset and the start sub-carrier/RB of the received supplementary/secondary cell access broadcast (e.g., SSB) transmission. In another example, a WTRU may be indicated with GFCN and/or ARFCN of the 6G CD-SSB request transmission associated with the GFCN and/or ARFCN of the supplementary/secondary cell access broadcast (e.g., SSB) transmission. In a further example, a WTRU may be indicated with a (pre)configured transmission pattern of 6G CD-SSB transmission(s) relative to the frequency resource of the received supplementary/secondary cell access broadcast (e.g., SSB) transmission.

In an embodiment, a WTRU may perform the request transmission within the time and frequency resource allocation indicated d (e.g., using an index) in the received supplementary/secondary cell access broadcast (e.g., SSB) transmission. A WTRU may perform the request transmission using a transmit spatial filter configuration (e.g., TX beam) corresponding to the receive spatial filter configuration (e.g., RX beam) applied to supplementary/secondary cell access broadcast (e.g., SSB) transmission. In another example, a WTRU may perform the 6G cell access broadcast (e.g., SSB) request transmission using a transmit spatial filter configuration (e.g., TX beam) corresponding to the SSB index indicated in supplementary/secondary cell access broadcast (e.g., SSB) transmission.

According to an embodiment, a WTRU may determine a 6G cell access broadcast (e.g., SSB) request transmission power as a function of the indicate 6G cell access broadcast (e.g., SSB) transmission power, the RSRP and/or RSSI of the received supplementary/secondary cell access broadcast (e.g., SSB) transmission and a (pre)configured a reference power level. In one example, a WTRU may determine the path loss based on the indicated 6G cell access broadcast (e.g., SSB) transmit power and the measured RSRP and/or RSSI level. A WTRU may further determine a transmit power as the sum of the path loss and the (pre)configured reference power level.

In an embodiment, a WTRU may monitor and receive a requested 6G CD-SSB transmission according to the information indicated in the supplementary/secondary cell access broadcast (e.g., SSB) transmission. For example, upon performing a request transmission indicated in a received supplementary/secondary cell access broadcast (e.g., SSB) transmission, the WTRU may monitor and receive a requested 6G CD-SSB transmission according to the information indicated in the supplementary/secondary cell access broadcast (e.g., SSB) transmission. In one embodiment, a WTRU may perform the monitoring within time and frequency resource allocation indicated in supplementary/secondary a WTRU may monitor and receive a requested 6G CD-SSB transmission according to the information indicated in the supplementary/secondary cell access broadcast (e.g., SSB) transmission.

Some embodiments may relate to WTRU behaviour upon no detection of 6G cell access broadcast (e.g., SSB) transmission. According to an embodiment, a WTRU may be (pre)configured with a time period for the detection and reception of one or more of the following: a 6G cell access broadcast (e.g., SSB) transmission based on information indicated in a received 5G PBCH, a 6G cell access broadcast (e.g., SSB) transmission in response to a performed 6G cell access broadcast (e.g., SSB) request transmission by the WTRU, a 6G cell access broadcast (e.g., SSB) transmission associated with received 5G PSS and SSS transmission, a 6G CD-SSB transmission based on information indicated in a received 6G supplementary/secondary cell access broadcast (e.g., SSB) transmission, and/or an explicit indication (e.g. RAR indication) in response to the 6G cell access broadcast (e.g., SSB) request transmission by the WTRU.

According to an embodiment, when a WTRU may not detect and receive any 6G cell access broadcast (e.g., SSB) transmission within the (pre)configured time period, the WTRU may stop detecting and receiving the associated 6G cell access broadcast (e.g., SSB) transmission. A WTRU may disregard the received information about the 6G cell access broadcast (e.g., SSB) transmission.

Some embodiments may include or may be directed to WTRU detection and/or reception of cell access information based on information indicated in default/primary and supplementary/secondary cell access broadcast (e.g., SSB) transmission(s).

In an embodiment, a WTRU may determine cell access information based on the following information indicated in, for example, at least two received 6G cell access broadcast (e.g., SSB) transmissions: supplementary and/or secondary 6G cell access information for a cell carried in a supplementary/secondary cell access broadcast (e.g., SSB) transmission, default and/or primary 6G cell access information of the same or a different cell carried in a default/primary cell access broadcast (e.g., SSB) transmission.

According to an embodiment, a WTRU may detect and/or receive synchronization and signal transmission and determines one or more PBCH DMRS sequences as discussed above with regard to the WTRU detection and/or reception of synchronization signal transmission. A WTRU may determine a default/primary cell access broadcast (e.g., SSB) transmission may be received when the received DMRS sequence may correspond to the (pre)configured DMRS sequence for a PBCH carrying default cell access information. In another example, a WTRU may be indicated in a bit-field in the received PBCH that default cell access information may be included in a received 6G cell access broadcast (e.g., SSB) transmission. A WTRU may determine one or more of the following default cell access information in the received default cell access broadcast (e.g., SSB) transmission: PCI, SFN, SCS, SSB index, SSB sub-carrier offset, and/or DMRS type.

In an embodiment, a WTRU may detect and/or receive a supplementary/secondary cell access broadcast (e.g., SSB) transmission using a same receive configuration as the one used to receive the default cell access broadcast (e.g., SSB) transmission. A receive configuration may include at least a receive spatial filter configuration. A WTRU may determine a supplementary/secondary cell access broadcast (e.g., SSB) transmission may be received when the received DMRS sequence may correspond to the (pre)configured DMRS sequence for a PBCH carrying supplementary cell access information. In another example, a WTRU may be indicated in a bit-field in the received PBCH that supplementary cell access information may be included in a received 6G cell access broadcast (e.g., SSB) transmission. In this example, a WTRU may use the DMRS sequence of the received default cell access broadcast (e.g., SSB) to decode the PBCH of the supplementary cell access broadcast (e.g., SSB) transmission. A WTRU may determine one or more of the following supplementary cell access information in the received supplementary cell access broadcast (e.g., SSB) transmission: SSB structure of the supplementary SSB transmission (e.g., periodicity, synchronization signal sequences, time and frequency resource allocation), PCI (e.g., an offset from the PCI derived from the default SSB transmission. In one example, an indication of zero offset may indicate the same PCI may be applied), additional parameters to acquire cell access information (SIB) that may not be available in default SSB transmission (e.g., PDCCH configuration, waveform, transmit power, etc.).

According to an embodiment, a WTRU may determine cell access information to acquire 6G system information (SIB1) by combining the default/primary and supplementary/secondary cell access information received in at least two cell access broadcast (e.g., SSB) transmissions. In one example, a WTRU may perform the combining in accordance with the following. A WTRU may determine one or more cell access cell access information as indicated in the default/primary SSB transmission, e.g., SCS, SSB offset, SFN and/or DMRS type indication. A WTRU may determine one or more cell access information by adjusting the received default/primary cell access information with the offset indicated in the received supplementary/secondary SSB transmission. In one example, a WTRU may be indicated with an offset in the received supplementary cell access information corresponding to an index offset of PDCCH configuration. An index of PDCCH configuration may denote a (pre)configured PDCCH resource allocation and monitoring pattern. A WTRU may determine a PDCCH configuration denoted by an index as the sum of the index indicated in the default cell access information and the offset indicated in the supplementary cell access information. In another example, a WTRU may be indicated with an offset in PCI. A WTRU may determine a PCI of a cell to receive system information transmission (SIB1) as the sum of the PCI derived from the default SSB transmission and the offset indicated in the supplementary cell access information. A WTRU may determine one or more cell access cell access information as indicated in the supplementary/secondary SSB transmission, e.g., SSB structure of the supplementary/secondary SSB transmission including SSB periodicity, PCI, transmit power and/or SSB time and frequency resources.

According to certain embodiments, the default/primary cell access broadcast (e.g., SSB) transmission may have small payload and may be broadcast more frequently and from multiple 6G cells. The supplementary/secondary cell access broadcast (e.g., SSB) transmission may have large payload and may be broadcast less frequently and may provide cell access information to a specific 6G cell, e.g., a small cell with low energy consumption.

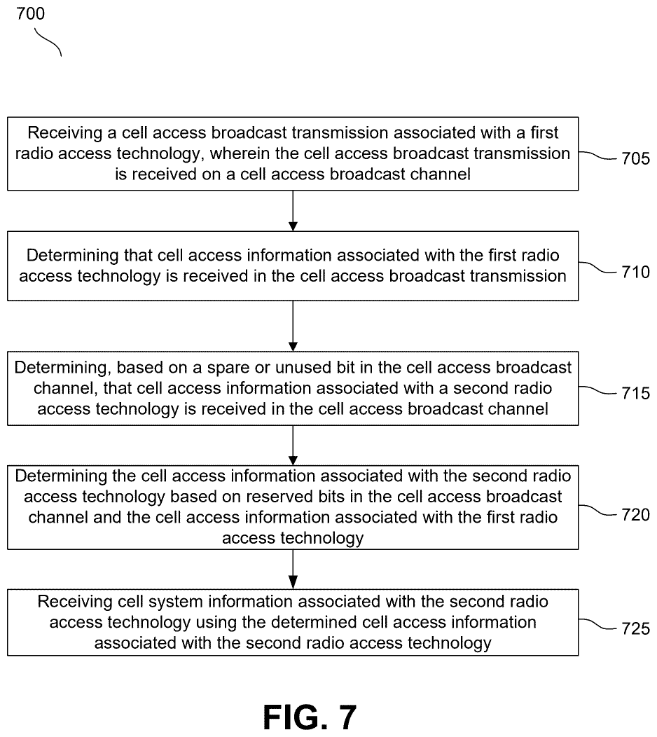

FIG. 7 illustrates an example flow diagram of a method 700 for or relating to detection and/or reception of 5G and/or 6G cell access information (e.g., MRSS cell access broadcast information), according to some embodiments. The example method 700 of FIG. 7 and accompanying disclosures herein may include, may be based on, or may be a synthesization of various embodiments or elements discussed in detail above.

For convenience and simplicity of exposition, the example of FIG. 7 may be described with reference to the architecture or system described above with respect to FIGS. 1A-1D, for instance. However, the example method 700 depicted in FIG. 7 may be carried out using different architectures as well. According to some embodiments, the method 700 of FIG. 7 may be performed or implemented by a UE or WTRU, such as the WTRU 102 described in the foregoing.

It is noted that the method 700 of FIG. 7 may include further steps, procedures or details as discussed in detail elsewhere in this disclosure. As such, the method 700 of FIG. 7 may be modified to include any of the steps, procedures, elements and/or details illustrated and/or discussed in the foregoing.

Moreover, it is noted that the method and/or blocks of FIG. 7 may be modified to include, or to be replaced by, any one or more of the procedures, elements or blocks discussed elsewhere herein. As such, one of ordinary skill in the art would understand that FIG. 7 is provided as one example and modifications thereto are possible while remaining within the scope of certain example embodiments.

As illustrated in the example of FIG. 7, the method 700 may include, at 705, receiving a cell access broadcast transmission associated with a first radio access technology (e.g., a first type of RAT or a first RAT type, such as 5G, 6G or any other current or future radio access system technology). The cell access broadcast transmission may be received on a cell access broadcast channel.

In the example of FIG. 7, the method 700 may include, at 710, determining that cell access information associated with the first radio access technology is received in the cell access broadcast transmission.

As illustrated in the example of FIG. 7, the method may include, at 715, determining, based on a spare or unused bit in the cell access broadcast channel, that cell access information associated with a second radio access technology (e.g., a second type of RAT or a second RAT type, such as 5G, 6G or any other current or future radio access system technology) is received in the cell access broadcast channel.

In the example of FIG. 7, the method 700 may include, at 720, determining the cell access information associated with the second radio access technology based on reserved bits in the cell access broadcast channel and the cell access information associated with the first radio access technology.

As illustrated in the example of FIG. 7, the method may include, at 725, receiving cell system information associated with the second radio access technology using the determined cell access information associated with the second radio access technology.

In an embodiment, the cell access broadcast transmission associated with the first radio access technology comprises a synchronization signal block (SSB).

In an embodiment, the first radio access technology comprises a 5G radio access technology.

In an embodiment, the second radio access technology comprises a 6G radio access technology.

In an embodiment, the cell access broadcast channel comprises a physical broadcast channel (PBCH).

In an embodiment, a value of the spare or unused bit in the cell access broadcast channel indicates that cell access information associated with the first radio access technology and cell access information associated with the second radio access technology is included in the cell access broadcast transmission associated with the first radio access technology.

In an embodiment, the method 700 may include determining a physical cell identity associated with the first radio access technology based on the cell access broadcast transmission.

In an embodiment, a value of the reserved bits indicates a physical cell identity associated with the second radio access technology.

In an embodiment, a value of the reserved bits indicates which cell access information associated with the second radio access technology is different from the corresponding cell access information associated with the first radio access technology.

In an embodiment, a value of the reserved bits indicate an offset from the cell access information associated with the first radio access technology, and the cell access information associated with the second radio access technology is determined based on the offset from the cell access information associated with the first radio access technology.

In an embodiment, the cell access information associated with the second radio access technology is determined based on a pre-configured offset applied relative to the cell access information associated with the first radio access technology.

In an embodiment, the cell system information associated with the second radio access technology comprises a system information block 1 (SIB1).

As discussed in detail above, some embodiments may include or may be directed to methods for WTRU reception of 6G cell access information based on reserved bits and/or re-used information fields in a received 5G SSB transmission.

In an embodiment, a WTRU may receive a 5G cell access broadcast transmission (e.g., on a cell access broadcast channel). For example, the 5G cell access broadcast transmission may be a 5G SSB and, in that case, the WTRU may detect and/or receive the 5G SSB.

In an embodiment, a WTRU may determine a 5G PCI. For example, the WTRU may detect a 5G PSS and/or SSS (e.g., included in the 5G SSB) and acquire time and frequency synchronization and the 5G PCI.

In an embodiment, a WTRU may determine that further 5G cell access information is received in the transmission. For example, the WTRU may determine the received cell access broadcast transmission (e.g., a 5G SSB) is a cell defining cell access broadcast transmission (e.g., CD-SSB). According to an embodiment, the WTRU may determine that the received cell access broadcast transmission (e.g., a 5G SSB) is a cell defining cell access broadcast transmission (e.g., CD-SSB) based on a value of an information field of SSB sub-carrier offset (K_{SSB}).

In an embodiment, a WTRU may determine that the cell access broadcast channel is carrying 6G cell access information, based on a spare or unused bit in the cell access broadcast channel. For example, the cell access broadcast channel may be a 5G PBCH and the WTRU may determine that the 5G PBCH is carrying 6G cell access information based on the spare bit in the MIB in the decoded PBCH. As an example, the value of the spare or unused bit may indicate that the PBCH is carrying both 5G and 6G cell access information and/or the value of the spare or unused bit may indicate that 6G cell access information is included in the 5G SSB.

In an embodiment, a WTRU may determine the 6G cell access information based on the reserved bits and/or received 5G cell access information in the cell access broadcast channel (e.g., in the decoded PBCH). For example, the value (e.g., codepoints) of the reserved bits may indicate which 6G cell access information may be different from the corresponding received 5G cell access information (e.g., the 5G PDCCH CORESET/Search Space configuration).

Additionally or alternatively, a value of the reserved bits may indicate an offset from (e.g., relative to) the 5G cell access information, and the WTRU may determine the 6G cell access information based on the indicated offset from the 5G cell access information (e.g., a value of the reserved bits may indicate an adjustment of the decoded 5G PBCH information to obtain the equivalent 6G cell access information, e.g., an offset from the index (decoded in PDCCH configuration bit field) of the 5G PDCCH CORESET/Search Space configuration). Additionally or alternatively, the WTRU may determine the 6G cell access information based on a (pre-) configured offset that may be applied relative to the 5G cell access information. In other words, the WTRU may determine the indicated 6G cell access information based on the received 5G cell access information and a (pre-) configured offset (e.g., PDCCH configuration for 5G is indicated with a value X and 6G value will be X+offset). According to some embodiments, the WTRU may determine that the remaining 5G cell access information, e.g., SFN, SCS, SSB index, SSB sub-carrier offset, DMRS type are identical (or similar) to the 6G cell access information. Additionally or alternatively, a value of the reserved bits may indicate a 6G PCI (which may be the same as or an offset from the decoded 5G PCI). It is noted that Table 1 shown below illustrates examples of the codepoint(s) indicating a commonality between 6G cell access information and 5G cell access information carried in 5G cell access broadcast transmission (e.g., 5G SSB)

In an embodiment, a WTRU may receive 6G cell system information (e.g., SIB1) using the determined 6G cell access information.

As can be seen from the above, certain embodiments may use the 5G cell defining cell access broadcast transmission (e.g., 5G CD-SSB transmission) to indicate 6G cell access information by taking advantage of the potential deployment with all or most 6G cell access information being identical (or similar) between 5G and 6G MRSS cell. The benefits include network energy saving by reducing and/or turning off 6G cell access broadcast transmissions (e.g., 6G SSB transmissions).

Alternatively, instead of (or in addition to) 6G cell access information, the reserved bits in the cell access broadcast channel (e.g., PBCH) may indicate 6G cell access broadcast transmission information (e.g., 6G SSB transmission information), i.e., the 5G cell defining cell access broadcast transmission (e.g., 5G CD-SSB transmission) may indicate 6G cell access information or 6G cell access broadcast transmission information (e.g., 6G SSB transmission information).

As discussed in detail above, some embodiments may include or may be directed to methods for WTRU determination of 6G cell access broadcast transmission information (e.g., 6G SSB transmission information) based on reserved bits and/or re-used information fields in a received 5G cell access broadcast transmission (e.g., 5G SSB transmission).

In an embodiment, a WTRU may detect and/or receive a 5G cell access broadcast transmission (e.g., 5G SSB). According to an embodiment, the WTRU may determine or acquire a 5G PCI based on the received cell access broadcast transmission. For example, the WTRU may detect synchronization signals (e.g., a 5G PSS and SSS) included in the 5G cell access broadcast transmission and may acquire time/frequency synchronization and/or a 5G PCI. In some embodiments, the WTRU may perform DMRS demodulation based on pre-defined sequences and/or may decode the corresponding 5G cell access broadcast channel (e.g., 5G PBCH).

In an embodiment, a WTRU may determine that further 5G cell access information is received in the transmission. For example, the WTRU may determine the received cell access broadcast transmission (e.g., a 5G SSB) is a cell defining cell access broadcast transmission (e.g., CD-SSB). According to an embodiment, the WTRU may determine that the received cell access broadcast transmission (e.g., a 5G SSB) is a cell defining cell access broadcast transmission (e.g., CD-SSB) based on a value of an information field of SSB sub-carrier offset (K_{SSB}).

In an embodiment, a WTRU may determine that the cell access broadcast channel is carrying 6G cell access information, based on a spare or unused bit in the cell access broadcast channel. For example, the cell access broadcast channel may be a 5G PBCH and the WTRU may determine that the 5G PBCH is carrying 6G cell access information based on the spare or unused bit in the MIB in the decoded PBCH. As an example, the value of the spare or unused bit may indicate that 6G cell access information is included in the 5G cell access broadcast transmission (e.g., 5G SSB).

In an embodiment, a WTRU may determine 6G cell access broadcast transmission information (e.g., 6G SSB transmission information) based on the reserved bits and/or unused information bits (e.g., PDCCH CORESET and Search Space configuration) in the cell access broadcast channel (e.g., in the decoded PBCH of the 5G NCD-SSB). For example, a value of the reserved bits and/or unused information bits may indicate any one or more of the following: timing and frequency resource (offset from received 5G SSB), periodicity, waveform, 6G PCI (e.g., same as or an offset from the decoded 5G PCI).

In an embodiment, a WTRU may detect and/or receive a 6G cell access broadcast transmission (e.g., 6G SSB) based on the received 6G cell access information. For example, the WTRU may be configured to apply QCL: ed relationship between the decoded 5G cell access broadcast transmission (e.g., 5G SSB) and the 6G cell access broadcast transmission (e.g., 6G SSB).

In view of the above, certain embodiments may be configured to re-use the unused bits in the cell access broadcast channel (e.g., PBCH) associated with a 5G cell access broadcast transmission (e.g., 5G NCD-SSB transmission) to provide information for a 6G WTRU to detect and receive a 6G cell access broadcast transmission (e.g., 6G SSB transmission). The benefits include network energy saving using sparse 6G cell access broadcast transmissions (e.g., 6G SSB transmissions) and WTRU processing reduction and power saving with reduced search range for blind scanning and detection of 6G SSB transmission.

Alternatively, instead of (or in addition to) 6G cell access broadcast transmission information (e.g., 6G SSB transmission information), 6G cell access information may be indicated, e.g., 5G NCD-SSB indicates 6G SSB transmission information or 6G cell access information (e.g., MIB).

As discussed in detail above, some embodiments may include or may be directed to methods for WTRU performing a transmission to request 6G cell access broadcast transmission (e.g., 6G SSB transmission) according to the request transmission information indicated in reserved bits and/or re-used information fields in a received 5G cell access broadcast transmission (e.g., 5G SSB transmission).

In an embodiment, a WTRU may detect and/or receive a 5G cell access broadcast transmission (e.g., 5G SSB). According to an embodiment, the WTRU may determine or acquire a 5G PCI based on the received cell access broadcast transmission. For example, the WTRU may detect synchronization signals (e.g., a 5G PSS and SSS included in the 5G cell access broadcast transmission) and may acquire time/frequency synchronization and/or a 5G PCI. In some embodiments, the WTRU may perform DMRS demodulation based on pre-defined sequences and/or may decode the corresponding 5G cell access broadcast channel (e.g., 5G PBCH).

In an embodiment, the WTRU may determine the received cell access broadcast transmission (e.g., a 5G SSB) is a cell defining cell access broadcast transmission (e.g., CD-SSB). According to an embodiment, the WTRU may determine that the received cell access broadcast transmission (e.g., a 5G SSB) is a non-cell defining cell access broadcast transmission (e.g., NCD-SSB) based on a value of an information field of SSB sub-carrier offset (K_{SSB}).

In an embodiment, a WTRU may determine that the 5G cell access broadcast channel (e.g. 5G PBCH) is carrying information for a 6G cell access broadcast transmission (e.g., 6G SSB transmission) request, based on a spare or unused bit in the cell access broadcast channel. For example, the cell access broadcast channel may be a 5G PBCH and the WTRU may determine that the 5G PBCH is carrying information for a 6G cell access broadcast transmission (e.g., 6G SSB transmission) request, based on the spare or unused bit in the MIB in the decoded PBCH. As an example, the value of the spare or unused bit may indicate the WTRU to transmit a request according to the information indicated in the 5G cell access broadcast channel (e.g., PBCH).

In an embodiment, a WTRU may determine 6G cell access broadcast transmission (e.g., 6G SSB transmission) request configuration based on the reserved bits and/or unused information bits (e.g., PDCCH CORESET and Search Space configuration) in the decoded cell access broadcast channel (e.g., PBCH) of the 5G non-cell defining cell access broadcast transmission (e.g., 5G NCD-SSB). For example, the 6G cell access broadcast transmission (e.g., 6G SSB transmission) request configuration may include any one or more of the following: SCS, timing and frequency resource (offset from received 5G SSB), waveform, TCI state, transmit power, and/or 6G PCI.

In an embodiment, a WTRU may perform a 6G cell access broadcast transmission (e.g., 6G SSB transmission) according to the determined cell access broadcast transmission request configuration.

As discussed in detail above, some embodiments may include or may be directed to methods for WTRU detection and/or reception of 6G cell access broadcast transmission (e.g., 6G SSB transmission) associated with 5G synchronization signal transmission (e.g., 5G PSS and SSS transmission).

In an embodiment, a WTRU may detect and/or receive 5G synchronization signal(s) (e.g., a 5G PSS and SSS), and may acquire time and frequency synchronization and/or determine a 5G PCI.

In an embodiment, a WTRU may determine a 6G cell access broadcast transmission (e.g., 6G SSB) search range (time and frequency) based on the 5G synchronization signal(s) (e.g., 5G PSS/SSS) timing, GSCN and/or the 5G PCI. For example, there may be a pre-configured association between 5G synchronization signal(s) (e.g., 5G PSS/SSS) timing, GSCN and/or 6G cell access broadcast transmission (e.g., 6G SSB) time and frequency resource range (e.g., the association can be a time offset and/or frequency raster offset from the detected 5G PSS and SSS). The 6G PCI may be the same as 5G PCI or with a pre-configured offset (from or relative to the 5G PCI).

In an embodiment, a WTRU may search and/or detects 6G cell access broadcast transmission (e.g., 6G SSB) in the indicated time and frequency resources. The DMRS sequence may be scrambled with the determined 6G PCI. The WTRU may apply QCL: ed relationship between the decoded 5G synchronization signal(s) (e.g., 5G PSS/SSS) and 6G cell access broadcast transmission (e.g., 6G SSB transmissions).

In an embodiment, a WTRU may receive 6G cell access broadcast channel (e.g., 6G PBCH) information from the 6G cell access broadcast transmission (e.g., 6G SSB transmission).

In view of the above, certain embodiments may re-use 5G PSS/SSS transmissions with pre-configured association to indicate 6G cell access broadcast transmission, e.g., a 6G SSB. The benefits include network energy saving by reducing the synchronization transmissions for 6G SSBs in a 6G MRSS cell. In network planning for a 6G MRSS cell, the 6G SSB transmissions may be placed in time and frequency resources associated with that of 5G SSB transmission.

As discussed in detail above, some embodiments may include or may be directed to methods for WTRU acquisition of 6G cell access information based on detected 6G broadcast indication transmission.

In an embodiment, a WTRU may detect and/or receive a 6G synchronization signal transmission and acquire time and frequency synchronization and a PBCIH indication (e.g., a pre-configured dedicated synchronization signal). The GSFN may be pre-configured for 6G MRSS cell.

In an embodiment, a WTRU may determine the 6G synchronization signal transmission is associated with a broadcast indication transmission based on indication in a supplementary and/or secondary SSB transmission.

In an embodiment, a WTRU may receive the supplementary/secondary SSB transmission using DMRS sequence determination based on SSB identifier and supplementary/secondary SSB transmission indication.

In an embodiment, a WTRU may receive any one or more of the following information for a 6G cell access broadcast channel transmission (e.g., a 6G CD-SSB) in the decoded broadcast indication transmission (e.g. an index to a pre-configured table): timing and frequency resource (e.g., relative offset), periodicity of 6G CD-SSB transmission, waveform used for 6G CD-SSB transmission, 6G PCI, and/or request indication.

In an embodiment, a WTRU may detect and/or receive a 6G cell access broadcast channel based on the received 6G cell access channel information. For example, a WTRU may apply QCL: ed relationship between the broadcast indication and 6G SSB transmissions.

In view of the above, certain embodiments can enable more frequent 6G broadcast indication transmissions with a much smaller payload of information regarding the sparser 6G cell access broadcast transmission (e.g., CD-SSB). It may serve the same purpose of a 5G NCD-SSB transmission such as time and frequency synchronization, measurement and monitoring. Additionally, the new information may assist a WTRU to detect a sparse CD-SSB without excessive WTRU processing. The benefits are a balanced tradeoff between network energy saving (reduced/turn-off 6G CD-SSB transmissions) and WTRU cell search performance (more detection of indication transmissions to assist CD-SSB acquisition).

As discussed in detail above, some embodiments may include or may be directed to methods for WTRU determination of supplementary and/or secondary 6G cell access from a 6G cell access broadcast transmission (e.g., 6G SSB transmission) based on information fields in a received default and/or primary 6G cell access broadcast transmission (e.g., 6G SSB transmission).

In an embodiment, a WTRU may detect and/or receive a default 6G cell access broadcast transmission (e.g., 6G SSB). For example, the WTRU may detect a 6G PSS and SSS and acquire time and frequency synchronization. The WTRU may perform DMRS demodulation based on pre-defined sequences and decodes the corresponding 6G PBCH. The WTRU may determine a primary PCI from the decoded default SSB.

In an embodiment, a WTRU may receive default cell access information in a default and/or primary SSB transmission. The default SSB transmission may be indicated in the PBCH or PBCH DMRS. The default cell access information may include, for example, SFN, SCS, SSB offset, and/or DMRS type.

In an embodiment, a WTRU may receive supplementary cell access information in a supplementary and/or secondary SSB transmission. The supplementary/secondary SSB transmission may be indicated in the PBCH or PBCH DMRS. The supplementary cell access information may include, for example, any one or more of the following: secondary/non-default SSB structure (e.g. periodicity, PSS/SSS sequencies, transmit power, SSB resource allocation), a supplementary 6G PCI (e.g., which may be the same as or an offset from the decoded default PCI), and/or additional information needed to receive associated 6G cell system information (SIB1). For example, the additional information may include an explicit indication to indicate an adjustment of the decoded default cell access information to determine the supplementary cell access information, e.g., an offset from the index of PDCCH configuration received in the default SSB to determine the PDCCH configuration of the cell. Additionally or alternatively, the additional information may include an explicit value indication to indicate additional parameters, e.g., a PCI of the cell.

In an embodiment, a WTRU may receive 6G cell system information (e.g. SIB1) using the determined cell access information.

In view of the above, certain embodiments can allow the network to avoid broadcast cell access information for every 6G cell (e.g., especially small cells saving energy). Within a given cell, some embodiments may allow the WTRU to determine secondary SSB structures within the cell.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

### REFERENCES

The following references may have been referred to hereinabove, each of which is incorporated herein by reference in its entirety:
[1] TS 38.211 Physical channels and modulation, v18.2.0, Section 7.3.3, 2024/03
[2] TS 38.211 Physical channels and modulation, v18.2.0, Section 7.4.3.1, 2024/03
[3] TS 38.212 Multiplexing and channel coding, v18.2.0, Section 7.1.1, 2024/03
[4] TS 38.331 Radio Resource Control (RRC) protocol specification, v18.2.0, Section 6.2, 2024/06.

What is claimed is:

1. A wireless transmit/receive unit (WTRU), comprising:
circuitry, including any of a processor, transmitter, receiver, and memory, configured to
receive a cell access broadcast transmission associated with a first radio access technology, wherein the cell access broadcast transmission is received on a cell access broadcast channel;
determine that cell access information associated with the first radio access technology is received in the cell access broadcast transmission;
determine, based on an unused bit in the cell access broadcast channel, that cell access information associated with a second radio access technology is received in the cell access broadcast channel;
determine the cell access information associated with the second radio access technology based on reserved bits in the cell access broadcast channel and the cell access information associated with the first radio access technology; and
receive cell system information associated with the second radio access technology using the determined cell access information associated with the second radio access technology.

2. The WTRU of claim 1, wherein the cell access broadcast transmission associated with the first radio access technology comprises a synchronization signal block (SSB).

3. The WTRU of claim 1, wherein the first radio access technology comprises a 5G radio access technology.

4. The WTRU of claim 1, wherein the second radio access technology comprises a 6G radio access technology.

5. The WTRU of claim 1, wherein the cell access broadcast channel comprises a physical broadcast channel (PBCH).

6. The WTRU of claim 1, wherein a value of the unused bit in the cell access broadcast channel indicates that cell access information associated with the first radio access technology and cell access information associated with the second radio access technology is included in the cell access broadcast transmission associated with the first radio access technology.

7. The WTRU of claim 1, configured to determine a physical cell identity associated with the first radio access technology based on the cell access broadcast transmission.

8. The WTRU of claim 1, wherein a value of the reserved bits indicates a physical cell identity associated with the second radio access technology.

9. The WTRU of claim 1, wherein a value of the reserved bits indicates which cell access information associated with the second radio access technology is different from the corresponding cell access information associated with the first radio access technology.

10. The WTRU of claim 1, wherein a value of the reserved bits indicate an offset from the cell access information associated with the first radio access technology, and wherein the cell access information associated with the second radio access technology is determined based on the offset from the cell access information associated with the first radio access technology.

11. The WTRU of claim 1, wherein the cell access information associated with the second radio access technology is determined based on a pre-configured offset applied relative to the cell access information associated with the first radio access technology.

12. The WTRU of claim 1, wherein the cell system information associated with the second radio access technology comprises a system information block 1 (SIB1).

13. A method, implemented by a wireless transmit/receive unit (WTRU), the method comprising:
receiving a cell access broadcast transmission associated with a first radio access technology, wherein the cell access broadcast transmission is received on a cell access broadcast channel;
determining that cell access information associated with the first radio access technology is received in the cell access broadcast transmission;
determining, based on an unused bit in the cell access broadcast channel, that cell access information associated with a second radio access technology is received in the cell access broadcast channel;
determining the cell access information associated with the second radio access technology based on reserved bits in the cell access broadcast channel and the cell access information associated with the first radio access technology; and
receiving cell system information associated with the second radio access technology using the determined cell access information associated with the second radio access technology.

14. The method of claim 13, wherein the cell access broadcast transmission associated with the first radio access technology comprises a synchronization signal block (SSB).

15. The method of claim 13, wherein the first radio access technology comprises a 5G radio access technology.

16. The method of claim 13, wherein the second radio access technology comprises a 6G radio access technology.

17. The method of claim 13, wherein the cell access broadcast channel comprises a physical broadcast channel (PBCH).

18. The method of claim 13, wherein a value of the unused bit in the cell access broadcast channel indicates that cell access information associated with the first radio access technology and cell access information associated with the second radio access technology is included in the cell access broadcast transmission associated with the first radio access technology.

19. The method of claim 13, comprising determining a physical cell identity associated with the first radio access technology based on the cell access broadcast transmission.

20. The method of claim 13, wherein a value of the reserved bits indicates a physical cell identity associated with the second radio access technology.

21. The method of claim 13, wherein a value of the reserved bits indicates which cell access information associated with the second radio access technology is different from the corresponding cell access information associated with the first radio access technology.

22. The method of claim 13, wherein a value of the reserved bits indicate an offset from the cell access information associated with the first radio access technology, and wherein the cell access information associated with the second radio access technology is determined based on the offset from the cell access information associated with the first radio access technology.

23. The method of claim 13, wherein the cell access information associated with the second radio access technology is determined based on a pre-configured offset applied relative to the cell access information associated with the first radio access technology.

24. The method of claim 13, wherein the cell system information associated with the second radio access technology comprises a system information block 1 (SIB1).
